(19) United States
(12) Patent Application Publication
(10) Pub. No.: US 2008/0028362 A1
(43) Pub. Date: Jan. 31, 2008

(54) Retracement data processing method and apparatus and retracement data evaluation method and apparatus

(75) Inventors: Takanori Ugai, Kawasaki (JP); Kouji Aoyama, Kawasaki (JP); Jun Arima, Kawasaki (JP); Noriyuki Kobayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/823,327

(22) Filed: Jun. 27, 2007

Related U.S. Application Data
(63) Continuation-in-part of application No. 11/546,093, filed on Oct. 11, 2006.

(30) Foreign Application Priority Data
Jul. 27, 2006 (JP) 2006-204277
Feb. 8, 2007 (JP) 2007-029689

(51) Int. Cl. G06F 9/44

(52) U.S. Cl. 717/101

(57) ABSTRACT

This invention is to automatically carry out the retracement of the knowledge. Therefore, this method is executed by a computer having a retracement data storage storing a target type of a past project, data concerning a scale of the past project, a specific phase of the past project, data concerning a problem in the specific phase of the past project, and data concerning an action against a problem in the specific phase of the past project. Then, this method comprises: obtaining project data including a target type of a project, data concerning a scale of the project, and a pertinent phase of the project; calculating an overall similarity for the retracement data of each past project, which is stored in the retracement data storage, by using a first similarity against the target type of the project, a second similarity against the data concerning the scale of the project, and a third similarity against the phase of the project; reading out, based on the overall similarity, from the retracement data storage, the data concerning the problem in the specific phase of the past project or the like.

### CROSS-REFERENCE TO RELATED APPLICATION

This is a continuation-in-part application of application Ser. No. 11/546,093, filed Oct. 11, 2006.

### TECHNICAL FIELD OF THE INVENTION

This invention relates to a technique to support studies of knowledge about various projects such as a system development, construction, and hardware development, and accumulate the knowledge.

### BACKGROUND OF THE INVENTION

Conventionally, a research is carried out in which an outline of a project is inputted to indicate an assumed risk. However, even if the risk is indicated, when executers themselves of the project do not carry out studies or do not take them root into themselves, the same mistake is repeated. In addition, a database storing failed cases is created, and the keyword search of the database can be carried out, for example. However, the cases are not arranged and provided so that the executers can materially carry out studies.

For example, JP-A-2001-265580 discloses a review supporting technique capable of preventing the omission of check items and supporting a review from the designing/preparing stage to the post processing, efficiently and precisely. Specifically, a review supporting system has means for inputting information peculiar to a project, which is composed of a project name of the project, a development purpose, development items and function outline, the type of the system/product, a development scale and development man-month, into a database of a client computer; means for searching and extracting a similar project from past projects registered in a database of a server computer based on the inputted information; means for searching and determining check items common to overall software products for each step and check items considered for each type from the characteristic of the system and/or product from the database of the server computer based on the further inputted information; means for extracting check items concerning the system and/or the product type from information of the similar project; means for determining unique check items for checking consistency between the input and the output or the like for each step unit of the project, and unifying all check items until this to input unified check items into the database of the client computer; means for inputting a result of a review by using a list of the unified check items into the database of the client computer; means for searching a problem point extracted as a result of the review from the information of the similar project, and utilizing the result for determination of a correction/measure method; and means for inputting final information that the problem points and the like are resolved into the database of the client computer, and further registering it into the database of the server computer. However, there is no disclosure of a specific method for searching and extracting the similar projects.

In addition, although there are some conventional techniques for evaluating an issue and/or a measure itself included in the retracement, there is no technique for objectively evaluating whether or not the retracement in a certain project is carried out well, or how much the project contributes to the retracement activity. The evaluation of the issue or measure in the conventional techniques is based on the evaluation by persons other than persons who registered the issue or measure, or the reuse by other issues or measures, and is not computed as a result of the retracement activity by the project, which registered the issues or measures, for example. In addition, it is impossible to judge only by finding the evaluation of the issue or measure whether or not the retracement is carried out well in the project, which registered the issues or measures.

For example, US-2006/0130096 discloses a technique for providing judgment data enabling the selection of a program by synthetically using evaluation results of individual programs. Specifically, an apparatus includes acquiring means for obtaining an audience rate of a predetermined program, program explanation, keywords, information concerning a broadcast time, information concerning casts of the program, remarks of the program, which are provided for a billboard site, and the number of remarks, the number of reuse times of billboard information, the number of comments provided for an official site of the program, and utilization history of the program in a predetermined terminal; numeric conversion means for carrying out numeric conversion for each of first to seventh elements, wherein the program explanation and the remarks of the program, which are provided for the billboard site are handled as the first element, the keywords are handled as a second element, the information concerning the broadcast time is handled as the third element, the number of remarks, which are provided for the billboard site, and the number of comments provided for the official site of the program are handled as the fourth element, the number of reuse times of the billboard information is handled as a fifth element, the audience rate and the utilization history are handled as a sixth element, and the information concerning the casts of the program is handled as a seventh element; evaluation means for evaluating the program based on the numeric values obtained by the numeric conversion by the numeric conversion means; schematizing means for collectively schematizing the evaluation results by the evaluation means; and presentation means for presenting the evaluation results schematized by the schematizing means.

In addition, JP-A-2005-32097 discloses a technique for enabling citizens to easily participate in evaluation of measures in a questionnaire format. Specifically, an apparatus includes a measure table storing plural measures, which are grouped into plural measure group; a question table storing plural questionnaires to select measures; an answer table storing the number of answers for each questionnaire in each measure; and processing means for selecting at least one measure for each questionnaire in each measure group, storing the number of answers for each questionnaire in each measure, and giving an order of the measure in a descending order of the number of answers.

Furthermore, JP-A-2006-18639 discloses a technique for evaluating an optimum measure taking into account influence to various issues when there are plural measures by clarifying a range of the influence where an arbitrary measure affects to the various issues, and calculating a unified evaluation reference against the measures. Specifically, an apparatus includes: effect calculation means for calculating an index of an effect of each measure against each issue from influence degree information indicating a value calculated by normalizing magnitude of the influence of each measure against each issue and a type representing good influence or bad influence and attainment degree information indicating a value calculated by normalizing a current attainment degree against each issue; and evaluation means for calculating a size of the effect for each measure based on the index of the effect of each measure against each issue.

For example, in order to study the past failures or the like and make them take root, it is said that the retracement is required. However, the self-examination is difficult. That is, there are problems in which he or she cannot find out what should be reflect, he or she forgets the past reflection, and there is no awareness of the solution or the like because he or she does not know what other people other than himself or herself carry out.

Because any appropriate retracement cannot be easily carried out by the conventional art, there are problems that the studies cannot be encouraged and taken root for the executors of the project.

### SUMMARY OF THE INVENTION

Therefore, an object of this invention is to provide a new technique to automatically carry out the retracement of the knowledge.

In addition, another object of this invention is to provide a technique to prevent the repeat of failures by appropriately carrying out the retracement of the knowledge.

Furthermore, still another object of this invention is to provide a technique to support accumulation of the knowledge.

In addition, the conventional techniques only individually evaluate the issue or measure itself included in the retracement data, and there is a problem that it is difficult for an executive in charge of the project, for example, to grasp whether or not the retracement is carried out well in the project, or how much the project contributes to the retracement activity.

Therefore, still another object of this invention is to provide a technique for objectively evaluating, in addition to evaluation for an issue or measure, whether or not the retracement is carried out well in a certain project, or how much the project contributes to the retracement activity.

A retracement data processing method according to a first aspect of this invention is executed by a computer having a storage unit and a retracement data storage storing a target type of a past project (e.g. a type of business of a company or the like using a system in a case of a system development project, a type of model or function in a case of a hardware development project, a type of building in a case of an architectural project or the like), data concerning a scale of the past project, a specific phase of the past project, data concerning a problem in the specific phase of the past project, and data concerning an action (e.g. a solution, a settlement plan, a remedy, an improvement plan or the like) against a problem in the specific phase of the past project. Then, the retracement data processing method comprises: obtaining project data including a target type of a project, data concerning a scale of the project, and a pertinent phase (e.g. identification information including the name of the phase or the like) of the project, and storing the data into the storage unit; calculating an overall similarity (e.g. a similarity in a first embodiment of this invention) for the retracement data of each past project, which is stored in the retracement data storage, by using a first similarity against the target type of the project, a second similarity against the data concerning the scale of the project, and a third similarity against the phase of the project, which are stored in the storage unit, and storing the calculated overall similarity into the storage unit; reading out, based on the overall similarity stored in the storage unit, from the retracement data storage, the data concerning the problem in the specific phase of the past project, or the data concerning the problem of the specific phase of the past project and the data concerning the action against the problem in the specific phase of the past project.

Effective data of the past project for the retracement is automatically extracted based on the first similarity against the target type of the project, the second similarity against the data concerning the scale of the project, and the third similarity against the pertinent phase of the project, which are said to experimentally be important. By carrying out such a processing, the retracement can be effectively carried out, and the repeat of the failure can be prevented.

In addition, the retracement data processing method may further comprise: obtaining data concerning a problem in the pertinent phase of the project, and storing the data into the storage unit; calculating a fourth similarity against the data concerning the problem in the pertinent phase of the project, which is stored in the storage unit, for the retracement data of the past project, which is stored in the retracement data storage, and modifying the overall similarity stored in the storage unit by using the fourth similarity; and reading out, based on the modified overall similarity, from the retracement data storage, the data concerning the action against the problem in the specific phase of the past project, or the data concerning the action against the problem in the specific phase of the past project and the data concerning the problem in the specific phase of the past project. It becomes possible to study measures or the like against the problem (e.g. an issue, a question or the like) from appropriate past cases. Incidentally, the overall similarity may be re-calculated, not modified.

The retracement data processing method may further include: obtaining data concerning an action against a problem in the pertinent phase of the project, and storing the data into the storage unit; calculating a fifth similarity against the data concerning the action against the problem in the pertinent phase of the project for the retracement of the past project, which is stored in the retracement data storage, and modifying the overall similarity stored in the storage unit by using the fifth similarity; reading out, based on the modified overall similarity, from the retracement data storage, the data concerning the action against the problem in the specific phase of the past project, or the data concerning the action against the problem in the specific phase of the past project and the data concerning the problem in the specific phase of the past project. It becomes possible to efficiently study by narrowing the measures against the problem or the like. Incidentally, the overall similarity can be re-calculated, not modified.

In addition, the retracement data processing method may further include: obtaining at least one of data concerning a delay of a schedule, data concerning a package program utilized in a system development, data concerning a hardware utilized in the system development, and data concerning an operating system utilized in the system development, and storing the obtained data into the storage unit. At that time, in the calculating the overall similarity, at least one of a similarity against the data concerning the delay of the schedule, a similarity against the data concerning the package program utilized in the system development, a similarity against the data concerning the hardware utilized in the system development, and a similarity against the data concerning the operating system utilized in the system development is further utilized to calculate the overall similarity. For example, it is effective for the system development.

Furthermore, the second similarity against the data concerning the scale of the project and the third similarity against the pertinent phase of the project are identified by judging whether or not a class corresponding to each of the data concerning the scale of the project and the pertinent phase of the project coincides with a predetermined class.

In addition, the aforementioned modifying by using the fourth similarity may include: generating a first vector concerning words appeared in the data concerning the problem in the pertinent phase of the project; generating a second vector concerning words appeared in the data concerning the problem in the specific phase of the past project; and calculating a similarity based on an inner-product of the first and second vectors by using the first and second generated vectors. For example, it is based on the Term Frequency—Inverse Document Frequency (TF-IDF) method.

Similarly, the aforementioned modifying by using the fifth similarity may comprises: generating a third vector concerning words appeared in the data concerning the action against the problem in the pertinent phase of the project; generating a fourth vector concerning words appeared in the data concerning the action against the problem in the specific phase of the past project; and calculating a similarity based on an inner-product of the third and fourth vectors by using the third and fourth generated vectors.

Furthermore, the retracement data processing method may further comprise: storing obtained data into the retracement data storage. By carrying out such a processing, in addition to the studies, further the knowledge can be accumulated.

A retracement data evaluation method according to a second aspect of this invention is executed by a computer having a retracement data storage storing retracement data including data concerning at least an issue of a project in association with a project ID of the project. Then, this retracement data evaluation method includes: extracting retracement data relating to a first project by searching the retracement data storage by the project ID of the first project, and calculating, by using the extracted retracement data relating to the first project, an adjustment score (e.g. adjustment score in a second embodiment) representing contribution to a retracement activity by the first project or a state of the retracement activity, and storing the adjustment score into a score table in association with specific retracement data relating to the first project; receiving second retracement data including an issue, which reuses a first issue included in the specific retracement data relating to the first project, and storing the second retracement data into the retracement data storage; and calculating an evaluation point (e.g. issue evaluation point in the second embodiment) of the first issue, which represents a usefulness degree of the first issue, in a form of adding the adjustment score for the first project, which is stored in association with the specific retracement data in the score table, by using the second retracement data, and storing the evaluation point of the first issue into the score table.

By calculating the evaluation point of the first issue in the form of adding the adjustment score for the first project, it is possible to present a score taking into account how much the project contributes to the retracement activity or whether or not the retracement is carried out well in the project in addition to the usefulness degree of the issue, for the executive in charge of the project, for example. By referring to the evaluation point, it is possible for the executive in charge of the project to urge members of the project to effectively utilize the retracement data.

In addition, the calculating the adjustment score may be executed at least one of a timing when the specific retracement data including the first issue is registered and a timing after the specific retracement data including the first issue was registered and when a predetermined time has passed since the calculating the adjustment score was executed (e.g. when the calculating the adjustment score is executed at 0:00 AM everyday, it is 0:00 AM of the next day of the day the specific retracement data is registered.) Thus, it is possible to reflect contribution to the retracement activity or a state of the retracement activity by the first project at a timing when the specific retracement data including the first issue is registered or at a timing when a predetermined period has passed since the specific retracement data was registered, to the evaluation point of the first issue. As a result, it is possible for the project executive in charge of the project to easily grasp the contribution to the retracement activity of the project or the state of the retracement activity of the project at a past timing.

Incidentally, it is possible to create a program for causing a computer to execute those methods according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a diagram showing a system outline according to the first embodiment of this invention;

FIG. 2 is a diagram showing an example of data stored in a progress management DB;

FIG. 3 is a diagram showing an example of data stored in a retracement DB;

FIG. 4 is a diagram showing a main processing flow in the first embodiment of this invention;

FIG. 5 is a diagram showing a processing flow of a first similar case search processing;

FIG. 6 is a diagram showing a processing flow of the first similar case search processing;

FIG. 7 is a diagram showing an example of a similarity list;

FIG. 8 is a diagram showing a first screen example;

FIG. 9 is a diagram showing a processing flow of a second similar case search processing;

FIG. 10 is a diagram showing a second screen example;

FIG. 11 is a diagram showing a processing flow of a third similar case search processing;

FIG. 12 is a diagram showing the main processing flow in the first embodiment of this invention;

FIG. 13 is a diagram showing a third screen example;

FIG. 14 is a diagram showing a fourth screen example;

FIG. 15 is a diagram showing a fifth screen example; and

FIG. 16 is a system outline diagram in a second embodiment of this invention;

FIG. 17 is a diagram showing an example of a retracement data table;

FIG. 18 is a diagram showing an example of a project data table;

FIG. 19 is a diagram showing an example of an issue data table;

FIG. 20 is a diagram showing an example of a measure data table;

FIG. 21 is a diagram showing an example of an issue scoring data table;

FIG. 22 is a diagram showing an example of a measure scoring data table;

FIG. 23 is a diagram showing an example of a project management table;

FIG. 24 is a diagram showing a main processing flow in the second embodiment of this invention;

FIG. 25 is a diagram showing a processing flow of an input processing;

FIG. 26A is a diagram showing a screen example of an input page;

FIG. 26B is a diagram showing a screen example of the input page;

FIG. 26C is a diagram showing a screen example of the input page;

FIG. 26D is a diagram showing a screen example of the input page;

FIG. 27 is a diagram showing a processing flow of a retracement data registration processing;

FIG. 28 is a diagram showing a processing flow of an issue data reuse judgment processing;

FIG. 29 is a diagram showing a processing flow of a measure data reuse judgment processing;

FIG. 30 is a diagram showing a processing flow of an issue point calculation processing;

FIG. 31 is a diagram showing a processing flow of an adjustment score calculation processing;

FIG. 32 is a diagram showing a processing flow of the adjustment score calculation processing;

FIG. 33 is a diagram showing a processing flow of the adjustment score calculation processing;

FIG. 34 is a diagram showing an example of a project data table;

FIG. 35 is a diagram showing a processing flow of an update processing;

FIG. 36 is a diagram showing an example of the project data table;

FIG. 37 is a diagram showing a processing flow of a display processing;

FIG. 38 is a diagram showing an example of the project data table;

FIG. 39 is a diagram showing a screen example of a first evaluation point display page;

FIG. 40 is a diagram showing a processing flow of a display change processing;

FIG. 41 is a diagram showing a screen example of a second evaluation point display page;

FIG. 42 is a diagram showing a screen example of a third evaluation point display page;

FIG. 43 is a diagram showing a screen example of a graph; and

FIG. 44 is a functional block diagram of a computer.

### DETAILED DESCRIPTION OF THE PREFERRED EMBODIMENTS

### Embodiment 1

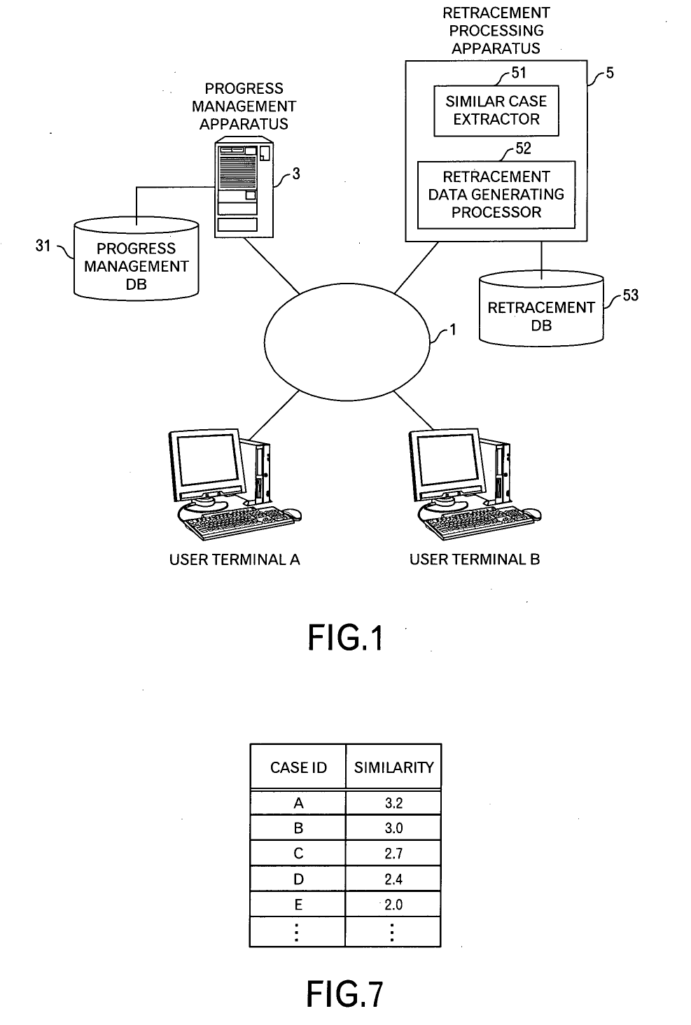

FIG. 1 shows a system outline according to the first embodiment of this invention. Hereinafter, an example in a system development such as a system integration will be described. For example, a network 1 such as a Local Area Network (LAN) is connected to a progress management apparatus 3 that manages a progress management database (DB) 31 storing data for the progress management of projects or the like (including data of the Work Breakdown Structure (WBS) or the like) a retracement processing apparatus 5 that carries out a main processing in this embodiment, and plural user terminal (in FIG. 1, a user terminal A, and a user terminal B).

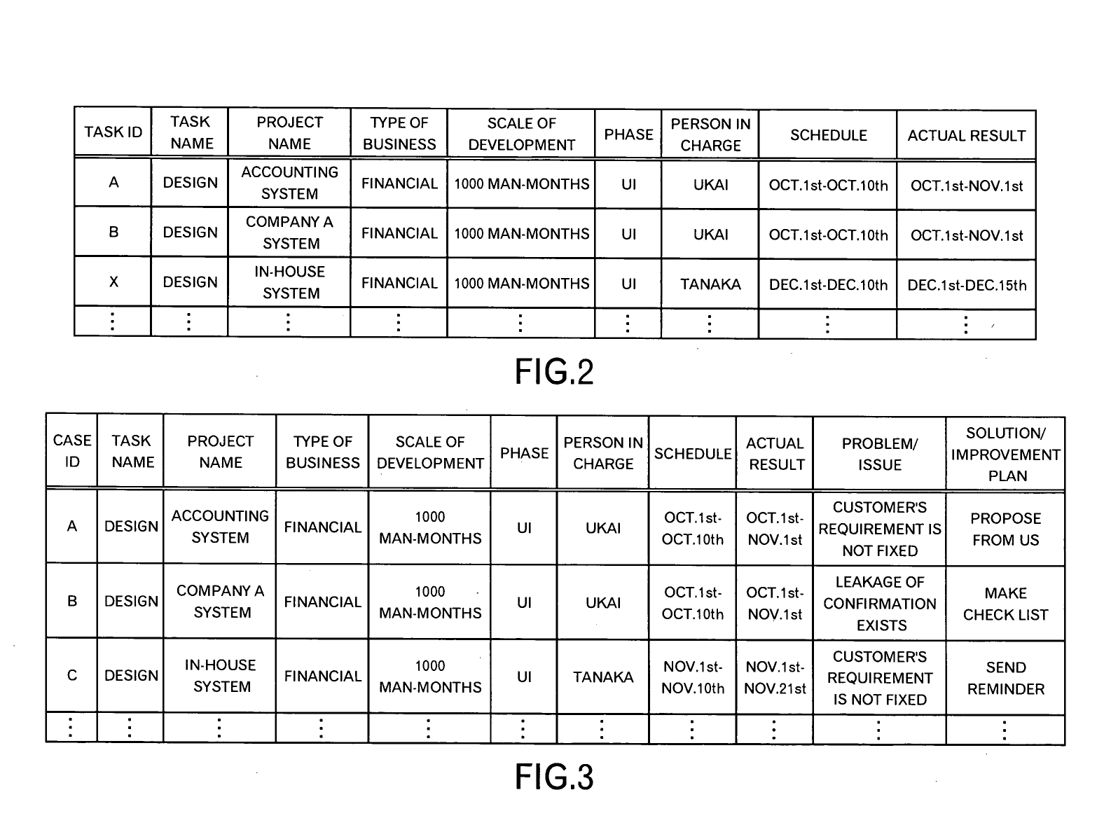

The progress management apparatus 3 and the progress management DB 31 are conventionally utilized, and the details of them are omitted. However, for example, data as shown in FIG. 2 is held. In the example in FIG. 2, a table stores a task ID, a task name, a project name, a target type of business of the project, a development scale, a pertinent phase, a person in charge of the project, a schedule of the pertinent phase, and an actual result of the pertinent phase. For example, the person in charge of the project operates the user terminal A or the like to transmit the aforementioned data to the progress management apparatus 3, and the progress management apparatus 3 receives the aforementioned data from the user terminal A or the like and stores the data into the progress management DB 31. In addition, the person in charge of the project operates the user terminal A or the like to request data of the project of which he or she is in charge, for example, when it is necessary, and the progress management apparatus 3 reads out data from the progress management DB 31 in response to the request, and transmits the read data to the user terminal A or the like. The user terminal A or the like receives data relating to the request from the progress management apparatus 3, and displays it on the display device.

Incidentally, although not shown, data concerning a name or type of the utilized package program, a hardware configuration in a component level, and a name or type of the Operating System (OS) may be stored in the progress management DB 31.

Moreover, the retracement processing apparatus 5 has a similar case extractor 51 that extracts data appropriate for causing the user to carry out the retracement (also called a similar case) from a retracement DB 53, and a retracement data generating processor 52 that obtains necessary task data from the progress management apparatus 3 or the user terminal, transmits data extracted by the similar case extractor 51 as an interface with the user, and registers, as the interface with the user, an issue/problem, a solution/improvement plan and the like, which are received from the user terminal, into the retracement DB 53.

For example, data as shown in FIG. 3 is stored in the retracement DB 53. In the example in FIG. 3, the table stores a case ID, a task name, a project name, a type of business, a development scale, a phase, a person in charge of the project, a schedule of the phase, an actual result of the phase, a problem/issue of the phase, and a solution/improvement plan. Incidentally, although not shown, data concerning a name or type of the utilized package program, a hardware configuration in a component level, a name or type of the OS and the like may also be stored in the retracement DB 53.

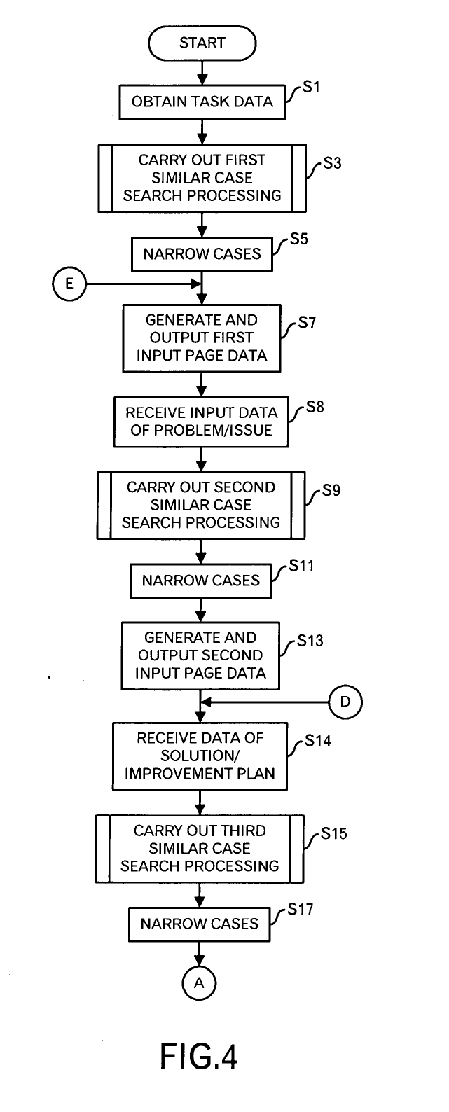

Next, a processing of the retracement processing apparatus 5 will be explained by using FIGS. 4 to 15. First, the retracement data generating processor 52 of the retracement processing apparatus 5 obtains, for example, a task ID from the user terminal A operated by a user A, for example, and requests the task data of the task ID to the progress management apparatus 3. The progress management apparatus 3 searches the progress management DB 31 by using the task ID or the like, reads out data (i.e. task data) of the corresponding record, and transmits it to the retracement processing apparatus 5. Incidentally, based on another data other than the task ID (e.g. a combination of a name of the person in charge of the project and a project name), the search may be carried out. The retracement data generating processor 52 of the retracement processing apparatus 5 obtains the task data by receiving it from the progress management apparatus 3 (step S1). By requesting the input for the user, the task data may be obtained from the user terminal A.

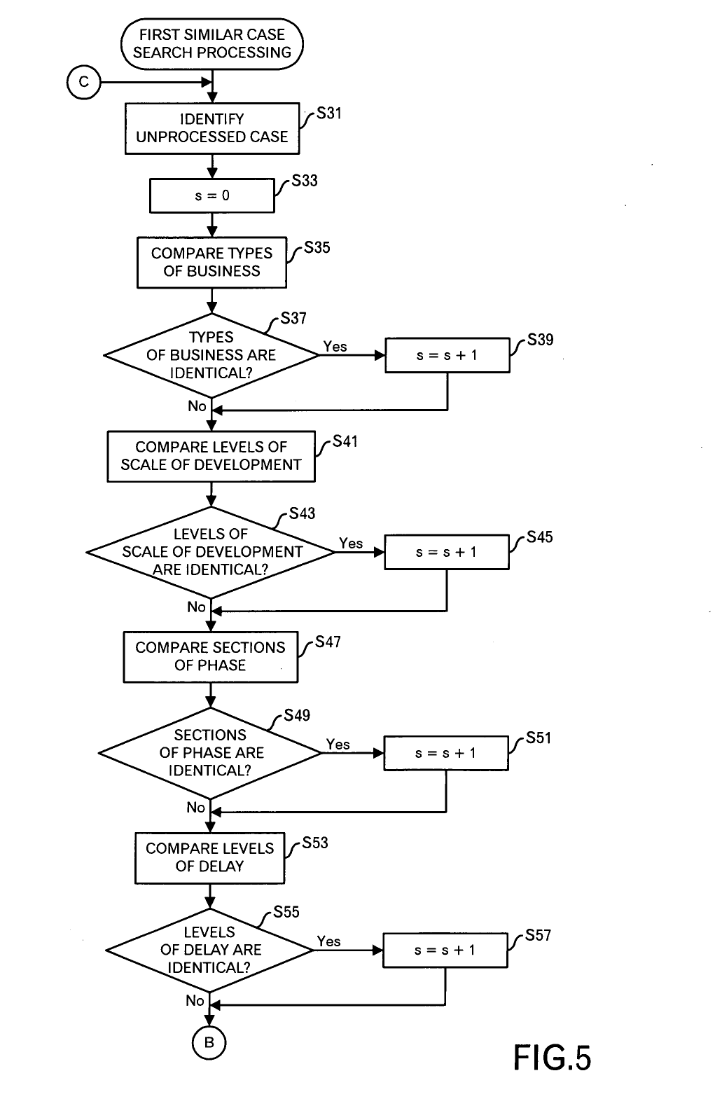

Next, the retracement data generating processor 52 outputs the obtained task data to the similar case extractor 51, and the similar case extractor 51 carries out a first similar case search processing based on the task data (step S3). The first similar case search processing will be explained by using FIGS. 5 to 7.

First, the similar case extractor 51 identifies one unprocessed case from the retracement DB 53 (step S31). Then, it initializes a similarity s to 0 (step S33). Then, it compares the type of business in the task data with the type of business in the identified case (step S35). When they coincides each other (step S37: Yes route), it increments the similarity s by 1 as the similarity of the type of business is 1 (step S39). Then, the processing shifts to step S41.

When the types of business do not coincide each other (step S37: No route), or after the step S39, it compares a level of the development scale in the task data with a level of the development scale in the identified case (step S41). For example, a level (also called a stage) equal to or less than 100 man-months, a level greater than 100 man-months and less than 1000 man-months, and a level equal to or greater than 1000 man-months are classified, and it is judged whether or not the levels are identical. When the levels of the development levels are identical (step S43: Yes route), it increments the similarity s by 1 as the similarity of the development scale is 1 (step S45). Then, the processing shifts to step S47.

When the levels of the development scale are not identical each other (step S43: No route), or after the step S45, it compares a phase section in the task data with a phase section in the identified case (step S47). For example, the phase is classified into a “pre” section, “after” section, and “maintenance” section, and it is judged whether or not the sections are identical each other. When the phase sections are identical each other (step S49: Yes route), it increments the similarity s by 1 as the similarity of the phase is 1 (step S51). Then, the processing shifts to step S53.

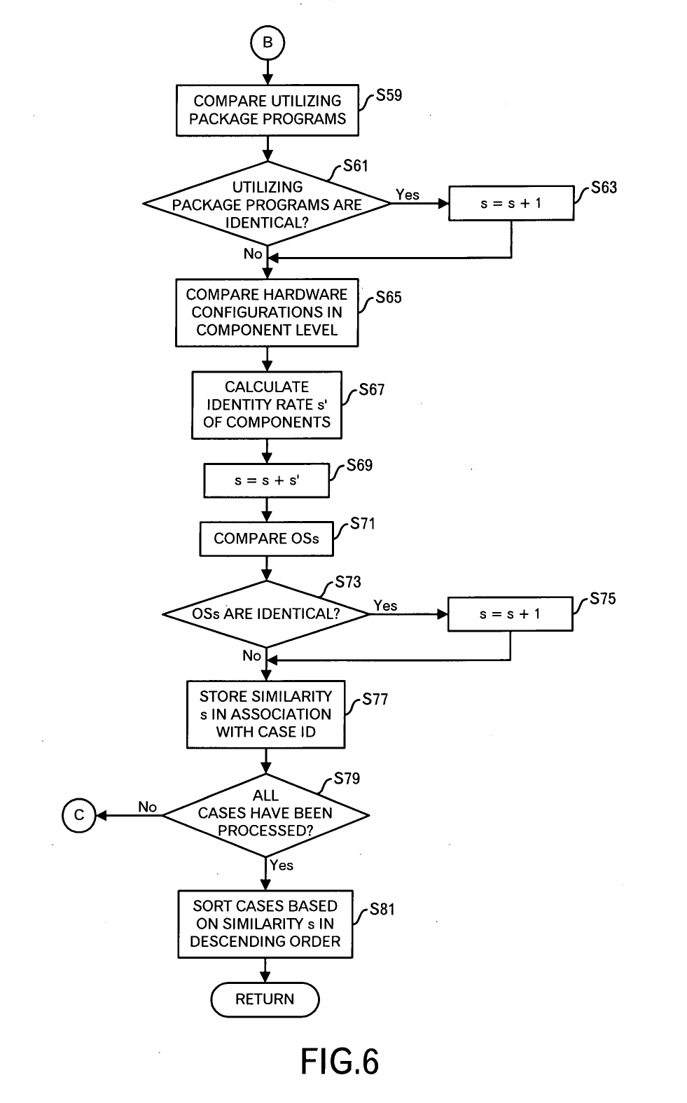

When the phase sections are not identical each other (step S49: No route), or after the step S51, it compares a level of the delay in the task data with a level of the delay in the identified case (step S53). First, it calculates the number of delay days that is a difference between the schedule (i.e. plan) and the actual result in the task data, and calculates the number of delay days that is a difference between the schedule (i.e. plan) and the actual result in the identified case, and stores them into a storage device such as a main memory. Then, the number of delay days are classified into a level of 3 days or less in the delay, a level of 4 days to 9 days in the delay, and a level of 10 days or more, and it is judged whether or not the levels of the delay are identical each other. When the levels of the delay are identical (step S55: Yes route), it increments the similarity s by 1 as the similarity of the delay is 1 (step S57). Then, the processing shifts to a processing of FIG. 6. When the levels of the delay are not identical (step S55: No route), the processing also shifts to the processing of FIG. 6.

Next, it compares a utilizing package program in the task data with a utilizing package program in the identified case (step S59). When the utilizing package programs are identical (step S61: Yes route), it increments the similarity s by 1 as a similarity of the utilizing package program is 1 (step S63). Then, the processing shifts to step S65.

When the utilizing package programs are not identical each other (step S61: No route), or after the step S63, it compares the hardware configuration in the task data with the hardware configuration in the identified case in the component level (step S65) For example, it judges whether or not the types of the CPU are identical each other, whether or not the types of the hard disk are identical each other, and the like. Then, it calculates an identity rate s′ of the components as a similarity in the hardware configuration by dividing the number of identical components by the total number of components, and stores the similarity s′ into the storage device such as a main memory (step S67). Then, it update the similarity s by s=s+s′ (step S69).

Furthermore, it compares the OS in the task data with the OS in the identified case (step S71). When the OSs are identical (step S73: Yes route), it increments the similarity s by 1 as the similarity of the OS is 1 (step S75). Then, the processing shifts to step S77.

When the OSs are not identical each other (step S73: No route) or after the step S75, it stores the similarity s into the storage device such as a main memory in association with the case ID (step S77). Then, it judges whether or not all of the cases in the retracement DB 53 have been processed (step S79). When there is an unprocessed case, the processing returns to the step S31. On the other hand, when all of the cases in the retracement DB 53 have been processed, it sorts the cases based on the similarity s in descending order (step S81). Then, the processing returns to the original processing.

For example, data as shown in FIG. 7 is obtained by the step S81. That is, the calculated similarity s is stored in association with the case ID, and the cases are arranged based on the similarity s in descending order.

Incidentally, when, in FIGS. 5 and 6, comparison is carried out for an item not included in either or both of the task data and the case data, it is judged as being not identical or the similarity “0”.

By carrying out such a processing, it becomes possible to extract cases judged as being similar in the first stage from a list as shown in FIG. 7.

For example, the similar case extractor 51 outputs the list as shown in FIG. 7 to the retracement data generating processor 62.

Then, the retracement data generating processor 52 narrows the cases to top predetermined-number cases from the list as shown in FIG. 7 (step S5), reads out data of corresponding problems/issues from the retracement DB 53 and data of the solutions/improvement plans by using the case IDs of the narrowed cases, and generate the first input page data to transmit the first input page data to the user terminal A, for example (step S7). Incidentally, when the similarities of the last cases among the top predetermined-number cases are the same, it is possible to select them even if the number of cases is greater than the predetermined number. In addition, it is possible to judge based on the value of the similarity, whether or not the case should be adopted. Moreover, only data of the problem/issue may be extracted.

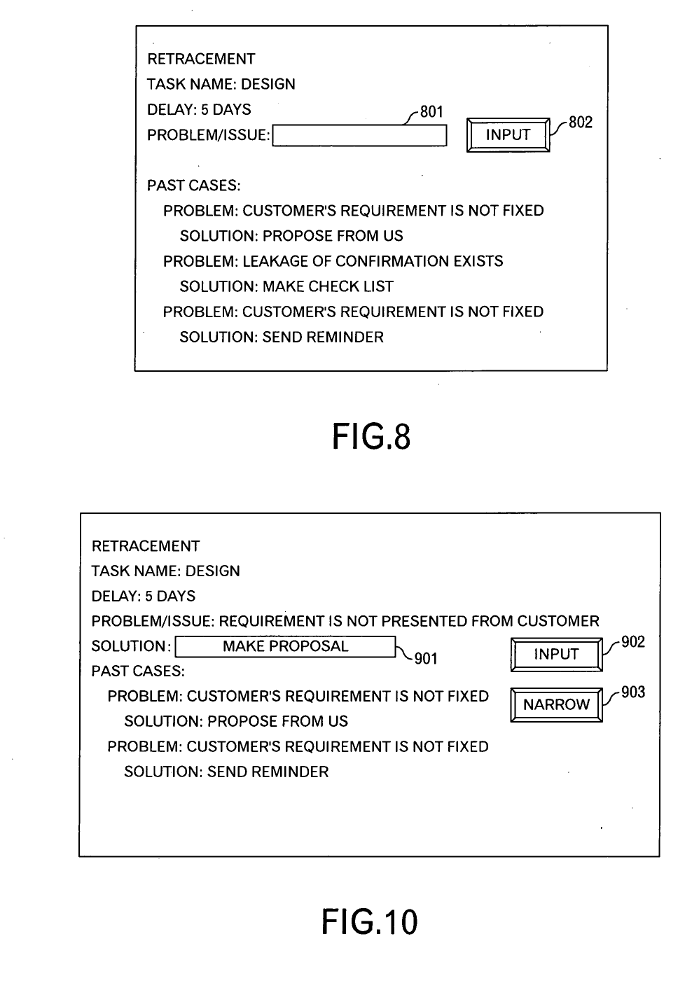

The user terminal A receives the first input page data from the retracement processing apparatus 5, and displays the first input page on the display device. For example, a screen as shown in FIG. 8 is displayed on the display device. In the example of FIG. 8, data whose case IDs of the cases stored in the retracement DB 53 shown in FIG. 3 are A, B and C is identified, and the screen includes the problem/issue and the solution/improvement plan as “past cases”. In addition, an input column 801 of the problem/issue in the task of this time, and an input button 802 are provided in the screen. Here, while the user A refers to the “past cases”, he or she input a problem/issue into the input column 801, and clicks the input button 802 to instruct the user terminal A to transmit the input data to the retracement processing apparatus 5. The user terminal A accepts the input from the user A, and transmits the data concerning the problem/issue to the retracement processing apparatus 5 according to the instruction.

The retracement data generating processor 52 of the retracement processing apparatus 5 receives data concerning the problem/issue from the user terminal A (step S8), and stores the data into the storage device such as a main memory. Then, it output the received data to the similar case extractor 51.

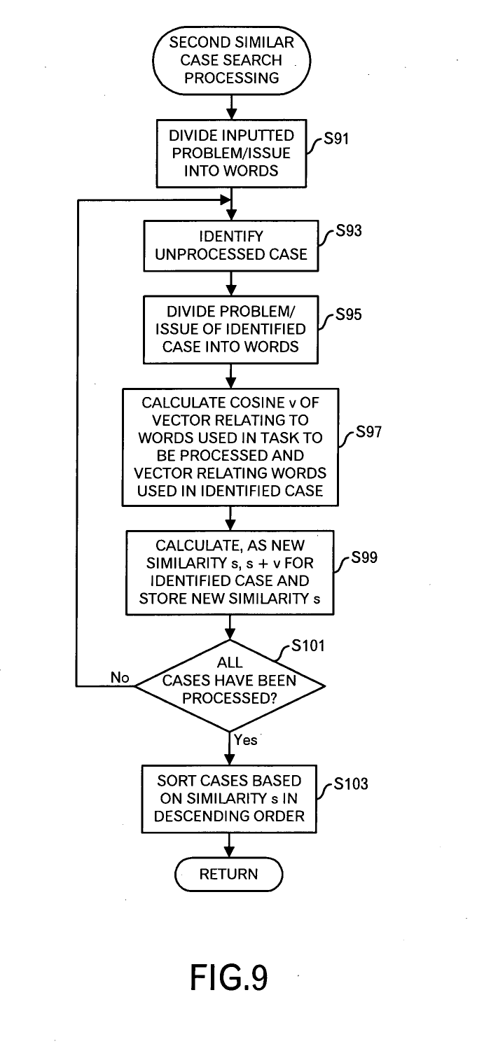

The similar case extractor 51 accepts the data from the retracement data generating processor 52, and carries out a second similar case search processing (step S9). This second similar case search processing will be explained by using FIG. 9.

First, the similar case extractor 51 divides a sentence or sentences of the problem/issue that is the received data into words, and stores them into the storage device such as a main memory (step S91). Then, it identifies one unprocessed case in the retracement DB 53 (step S93). Incidentally, it is possible to simplify the processing, for example, by identifying one unprocessed case in the top 20, for example, of the list as shown in FIG. 7, not an unprocessed case in the retracement DB 53. It is also possible to identify one unprocessed case having the similarity equal to or greater than a predetermined similarity, not top 20 or the like. Incidentally, “20” is mere an example.

Next, it obtains a sentence or sentences of the problem/issue of the identified unprocessed case from the retracement DB 53, divides the sentence or sentences into words, and stores them into the storage device such as a main memory (step S95). Then, it calculates a TF-IDF value for each word with respect to each of the task to be processed and the identified case, generates a vector p of the task to be processed and a vector q of the identified case based on the calculated TF-IDF values, calculates, as a similarity of the problem/issue, a cosine v (=(inner-product of p and q)/|p|/|q|. The value of the cosine is from 0 to 1.) of the vectors p and q, and stores the similarity of the problem/issue into the storage device such as a main memory (step S97).

After that, it calculates, as a new similarity s, a sum (s+v) of the similarity s, which has been calculated for the identified case, and the cosine v, and stores the sum into the list as shown in FIG. 7 (step S99). Then, it judges whether or not all of the cases have been processed (step S101). Also in this case, it is possible to restrictively judge whether or not there is an unprocessed case like in the step S93. When there is an unprocessed case, the processing returns to the step S93. On the other hand, when all of the cases have been processed, it sorts the cases based on the similarity s in descending order (step S103). Although the order is changed, the data as shown in FIG. 7 is obtained.

Thus, as for the past cases, while considering the data of the problem/issue into account, the similarity is calculated. Incidentally, Although, in the second similar case search processing, the result of the first similar case search processing is used to omit the first similar case search processing itself, the second similar case search processing may be carried out in addition to the first similar case search processing, or in addition to the first similar case search processing in which thresholds such as the level and the section are changed.

For example, the similar case extractor 51 outputs the list as shown in FIG. 7 to the retracement data generating processor 52.

Returning to the explanation of FIG. 4, the retracement data generating processor 52 narrows the cases to the top predetermined-number cases from the list as shown in FIG. 7 (step S11), reads out data of the corresponding problems/issues and data of the corresponding solutions/improvement plans from the retracement DB 53 by using the case IDs of the narrowed cases, generate a second input page data by using the read data to transmit the second input page data to the user terminal A, for example (step S13). Incidentally, when the last cases among the top predetermined-number cases have the same value, it is possible to select the cases even if the number of cases is over the predetermined number. In addition, it is possible to judge based on the value of the similarity whether or not the case should be adopted. Moreover, it is possible to extract only the data of the problems/issues or only the data of the solutions/improvement plans.

The user terminal A receives the second input page data from the retracement processing apparatus 5, and displays the second input page on the display device. For example, when “any requirement is not presented from the customer” is inputted in the input column 801 of the screen in FIG. 8, and the input button 802 is clicked, a screen as shown in FIG. 10 is displayed on the display device, for example. In the example of FIG. 10, data whose case IDs of the cases stored in the retracement DB 53 shown in FIG. 3 are A and C is identified in the step S11, and the screen includes their problems/issues and solutions/improvement plans as the “past cases”. In addition, an input column 901 of the problem/issue for this task, an input button 902, and a narrow button 903 are provided on the screen. At this stage, any data is not inputted in the input column 901.

Here, while the user A refers to the “past cases”, he or she inputs the solution/improvement plan (e.g. “make a propose”) into the input column 901, and clicks the input button 902 or the narrow button 903 to instruct the user terminal A to transmit the input data to the retracement processing apparatus 5. The user A accepts the input from the user A, and transmits the data concerning the solution/improvement plan according to the instruction to the retracement processing apparatus 5.

The retracement data generating processor 52 of the retracement processing apparatus 5 receives the data concerning the solution/improvement plan from the user terminal A (step S14), and stores the data into the storage device such as a main memory. Then, it outputs the received data to the similar case extractor 51.

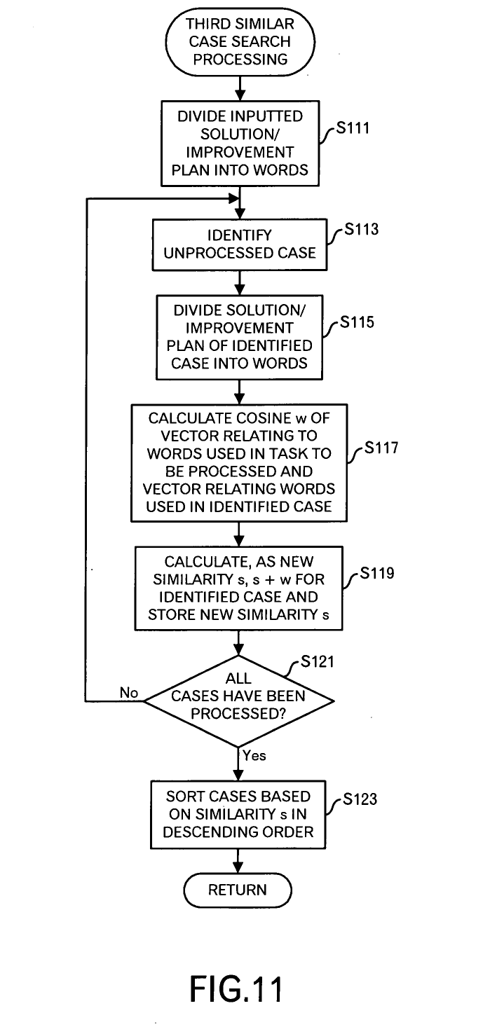

Then, the similar case extractor 51 receives the data from the retracement data generating processor 52, and carries out a third similar case search processing (step S15). This third similar case search processing will be explained by using FIG. 11.

First, the similar case extractor 51 divides a sentence or sentences of the solution/improvement plan that is the received data into words, and stores them into the storage device such as a main memory (step S111). Then, it identifies one unprocessed case in the retracement DB 53 (step S113). Incidentally, it is possible to simplify the processing, for example, by identifying one unprocessed case in the top 20, for example, of the list as shown in FIG. 7, not an unprocessed case in the retracement DB 53. It is also possible to identify one unprocessed case having the similarity equal to or greater than a predetermined similarity, not top 20 or the like. Incidentally, “20” is mere an example.

Next, it obtains a sentence or sentences of the solution/improvement plan of the identified unprocessed case from the retracement DB 53, divides the sentence or sentences into words, and stores them into the storage device such as a main memory (step S115). Then, it calculates a TF-IDF value for each word with respect to each of the task to be processed and the identified case, generates a vector p of the task to be processed and a vector q of the identified case based on the calculated TF-IDF values, calculates, as a similarity of the solution/improvement plan, a cosine w (=(inner-product of p and q)/|p|/|q|. The value of the cosine is from 0 to 1.) of the vectors p and q, and stores the similarity of the solution/improvement plan into the storage device such as a main memory (step S117).

After that, it calculates, as a new similarity s, a sum (s+w) of the similarity s, which has been calculated for the identified case, and the cosine w, and stores the sum into the list as shown in FIG. 7 (step S119). Then, it judges whether or not all of the cases have been processed (step S121). Also in this case, it is possible to restrictively judge whether or not there is an unprocessed case like in the step S113. When there is an unprocessed case, the processing returns to the step S113. On the other hand, when all of the cases have been processed, it sorts the cases based on the similarity s in descending order (step S123). Although the order is changed, the data as shown in FIG. 7 is obtained.

Thus, as for the past cases, while considering the data of the solution/improvement plan into account, the similarity is calculated. Incidentally, although, in the third similar case search processing, the result of the first similar case search processing and the second similar case search processing is used to omit the first and second similar case search processings themselves, the third similar case search processing may be carried out in addition to the first and the second similar case search processing, or in addition to the first similar case search processing and the second similar case search processing in which thresholds such as the level and the section are changed.

For example, the similar case extractor 51 outputs the list as shown in FIG. 7 to the retracement data generating processor 52.

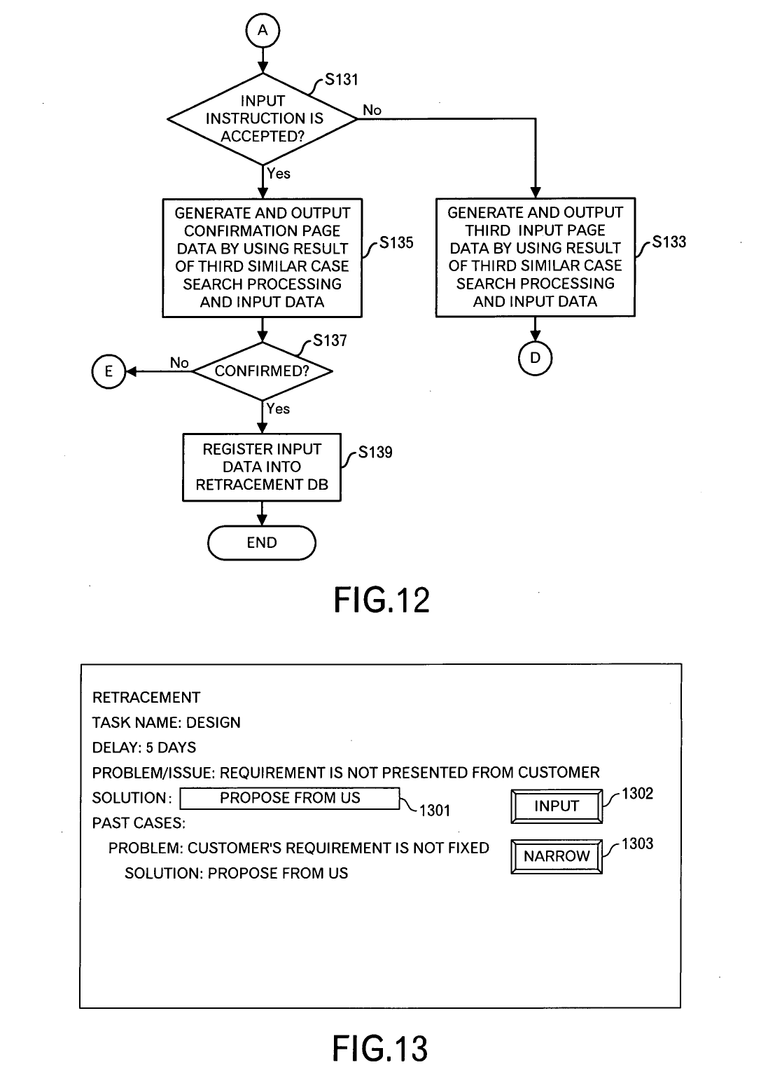

The retracement data generating processor 52 narrows the cases to the top predetermined-number cases from the list as shown in FIG. 7 (step S17). The predetermined number may be different from that in the step S5, S11 or S17. After that, the processing shifts to a processing of FIG. 12 via a terminal A.

The retracement data generating processor 52 judges whether the input button 902 on the screen shown in FIG. 10 is clicked to instruct the input, or the narrow button 903 is clicked to instruct the narrowing (step S131).

When the narrowing is instructed (step S131: No route), the retracement data generating processor 52 generates third input page data by using the result of the third similar case search processing and the input data (data relating to the problem/issue, and data relating to the solution/improvement plan), and transmits the third input page data to the user terminal A (step S133).

The user terminal A receives the third input page data from the retracement processing apparatus 5, and displays it on the display device. For example, when an input “propose from us” is carried out and the narrow button 903 is clicked, a screen as shown in FIG. 13 is displayed on the display device, for example. In the example of FIG. 13, data of a case whose case ID is A, which is stored in the retracement DB 53 shown in FIG. 3, is identified at the step S17, and its problem/issue and solution/improvement plan are included in the “past cases”. In addition, an input column 1301 of the solution/improvement plan, into which “propose from us” inputted into the input column 901 on the screen of FIG. 10 is embedded, an input button 1302, and a narrow button 1303 are provided.

While referring to the narrowed “past cases”, the user A can change the input content. Then, he or she clicks the input button 1302 or the narrow button 1303 to instruct the user terminal A to transmit the input data to the retracement processing apparatus 5. The user terminal A accepts the input from the user A, and transmits the data relating to the solution/improvement plan according to the instruction to the retracement processing apparatus 5. The processing returns to the step S14 of FIG. 4 via a terminal D.

On the other hand, when the input is instructed (step S131: Yes route), the retracement data generating processor 52 generates confirmation page data by using the result of the third similar case search processing and the input data (the data relating to the problem/issue and the data relating to the solution/improvement plan), and transmits it to the user terminal A (step S135).

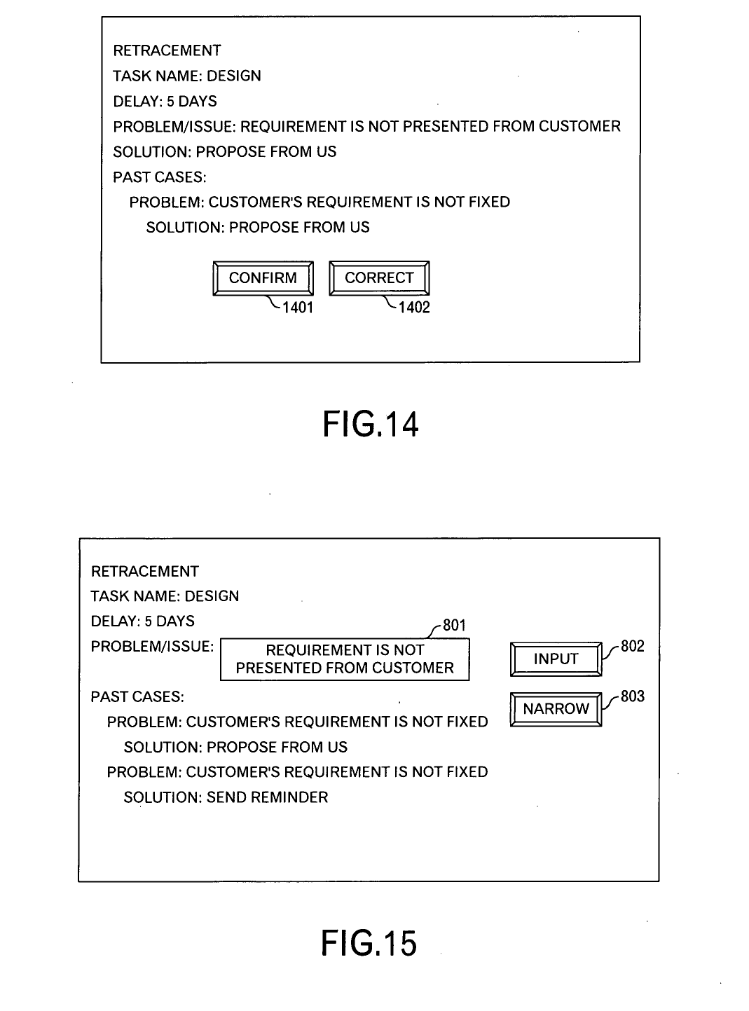

The user terminal A receives the confirmation page data from the retracement processing apparatus 5, and displays it on the display device. For example, a screen as shown in FIG. 14 is displayed on the display device. In the example of FIG. 14, the input data (“any requirement is not provided from customers” and “propose from us”) is displayed, and data of a case whose case ID of the case, which is stored in the retracement DB 53 shown in Fig. is A, is identified at the step S17 as the “past cases”. Furthermore, a confirm button 1401 and a correct button 1402 are provided, and when registering as it is, the confirm button 1401 is clicked, and when the input is corrected, the correct button 1402 is clicked. The user terminal A accepts the instruction input from the user, and transmits data relating to the instruction to the retracement processing apparatus 5.

The retracement data generating processor 52 of the retracement processing apparatus 5 receives the data relating to the instruction from the user terminal A, and judges whether or not the confirmation is instructed or not (step S137). When the correction was instructed (step S137: No route), the processing returns to the step S7 of FIG. 4 via a terminal E. However, when the categorization is carried out into a case where the problem/issue is corrected and a case where the solution/improvement plan is corrected, it is possible to ask the user A again, and to return to the step S13 when the latter case is adopted.

On the other hand, when the confirmation instruction was carried out (step S137: Yes route), the retracement data generating processor 52 registers data obtained at the step S1 and the input data received at the steps S8 and S14 into the retracement DB 53 (step S139) That is, one record is added in the data shown in FIG. 3.

When the processing as described above is carried out, while retracing the past cases, the user can input the problem/issue and the solution/improvement plan for this task, carry out the reflection and utilize the experience in the subsequent actions. That is, the similar failure can be prevented. In addition, the knowledge, which can be utilized by other users in future, can be accumulated.

As described above, although the first embodiment of this invention was described, this invention is not limited to this embodiment. Specifically, the functional block diagram shown in FIG. 1 is mere an example, and it does not always correspond to the program module configuration.

Moreover, when the solution/improvement plan is inputted, the input button 1401 and the correct button 1402 are provided, and when the problem/issue is inputted, only the input button 801 is provided in FIG. 8. However, as indicated in FIG. 15, the narrow button 803 can be provided. When the narrow button 803 is clicked, the “past cases” are narrowed by the second similar case search processing that is carried out based on the data inputted in the input column 801, and the screen as shown in FIG. 15 is displayed, for example.

In addition, although the example using TF-IDF was indicated, it is possible to calculate the word-based similarity by using other techniques.

Furthermore, although the application example to the projects of the system development was explained, this invention can be applied to projects of a hardware development or architectural projects. In an example of a storage system development, instead of the type of business, it is necessary to manage data of types such as a drive, controller, cabinet, and firmware. Moreover, in a case of the architectural project, it is necessary to manage data of the type of building such as a residence, office building, and bridge.

Furthermore, according to each case, the definition of the levels, the definition of the sections, the settings of the thresholds are adjusted. Therefore, the aforementioned example is mere an example.

### Embodiment 2

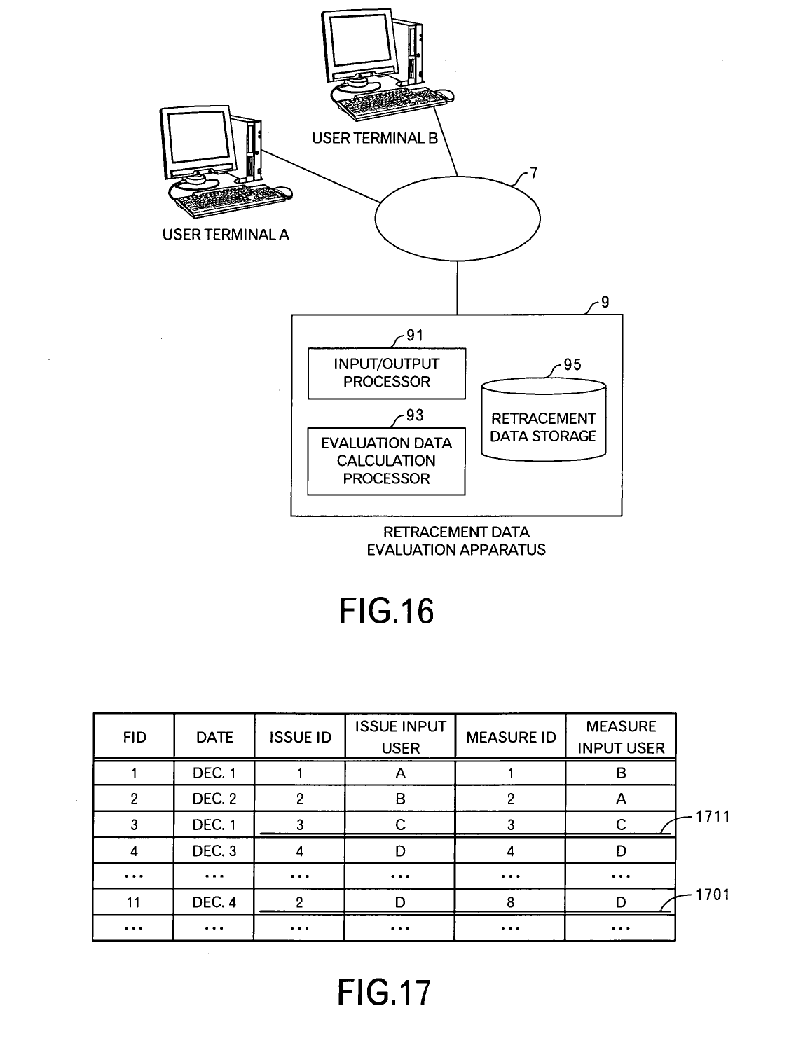

FIG. 16 shows a system outline according to a second embodiment of this invention. In the following, an example in the system development such as a system integration is shown. In addition, the retracement data in this embodiment includes data concerning an issue and data concerning measures for the issue. A network 7 such as Local Area Network (LAN) is connected with a retracement data evaluation apparatus 9, which carries out a main processing in this embodiment, and plural user terminals (in FIG. 16, user terminals A and B) Incidentally, in FIG. 16, two user terminals are shown, but the number of user terminals is not limited to two.

The retracement data evaluation apparatus 9 has a retracement data storage 95, an input/output processor 91 that receives data concerning the issue and measures, which was input in the user terminal, and registers the received data into the retracement data storage 95, and generates page data in response to a request received from the user terminal to transmit the page data to the user terminal, and an evaluation data calculation processor 93 that reads out data from the retracement data storage 95 to calculate evaluation points of the issue and the measures and calculate an adjustment score of the project.

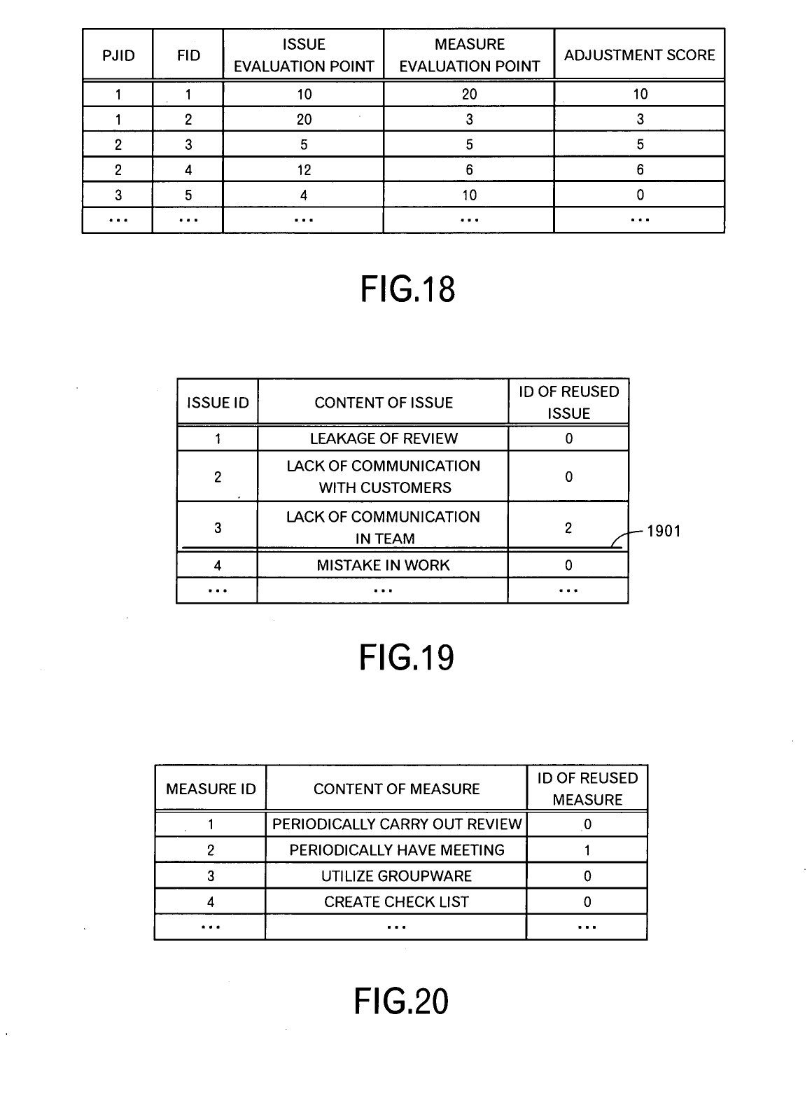

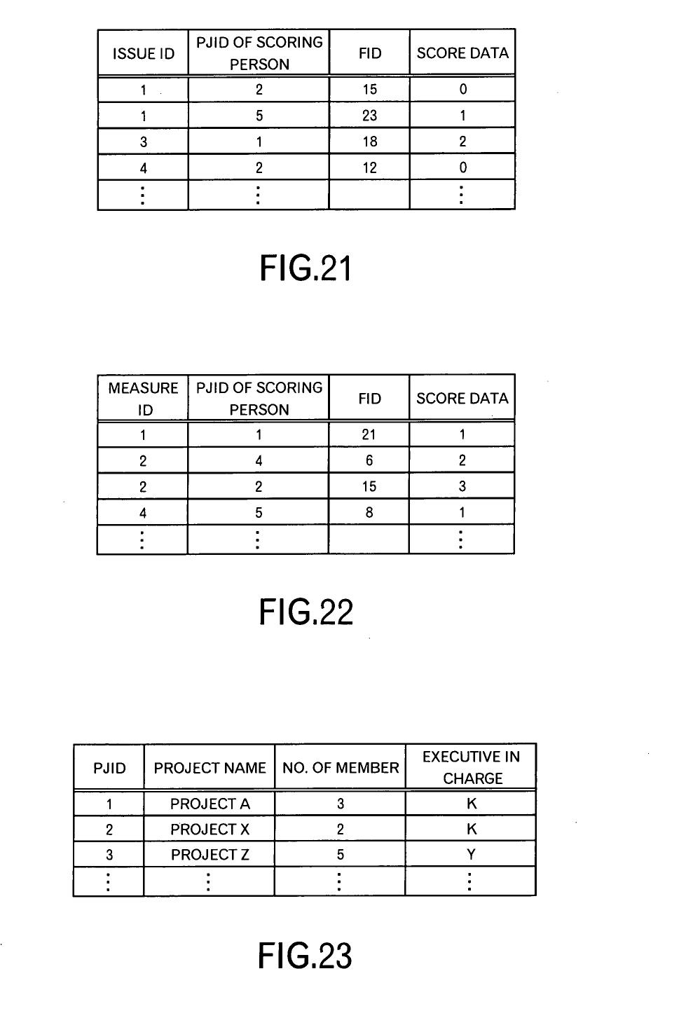

The retracement data storage 95 stores data as shown in FIGS. 17 to 23. FIG. 17 shows a retracement data table, in which an FID (retracement ID), which is information to identify the retracement data, a date, an issue ID, an issue input user ID, a measure ID, and a measure input user ID are registered. FIG. 18 shows a project data table, in which a PJID (project ID), which is information to identify a project, the FID, an issue evaluation point, a measure evaluation point, and the adjustment score are registered. FIG. 19 shows an issue data table, in which the issue ID, content of the issue, and an ID of a reused issue are registered. FIG. 20 shows a measure data table, in which the measure ID, content of the measure, and an ID of a reused measure are registered. FIG. 21 shows an issue scoring data table, in which the issue ID, the PJID of a scoring person, the FID, and score data are registered. FIG. 22 shows a measure scoring data table, in which the measure ID, the PJID of the scoring person, the FID, and score data are registered. FIG. 23 shows a project management table, in which the PJID, a project name, the number of members, and an ID of an executive in charge are registered.

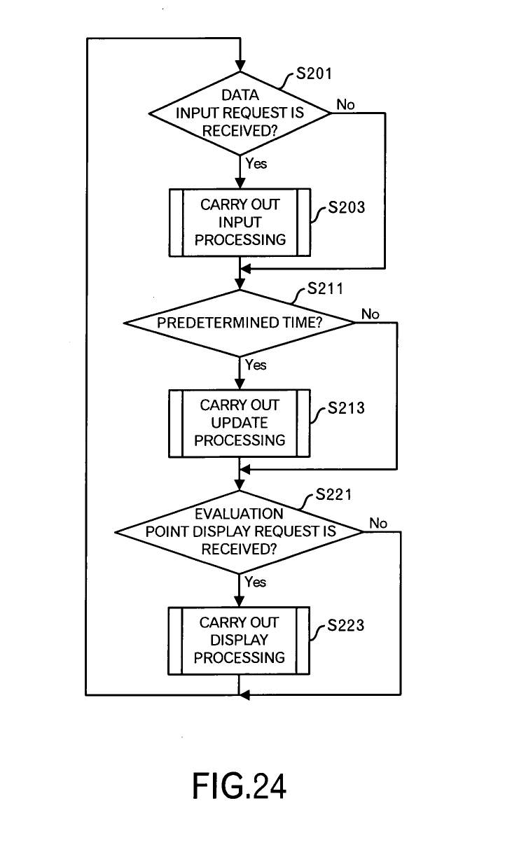

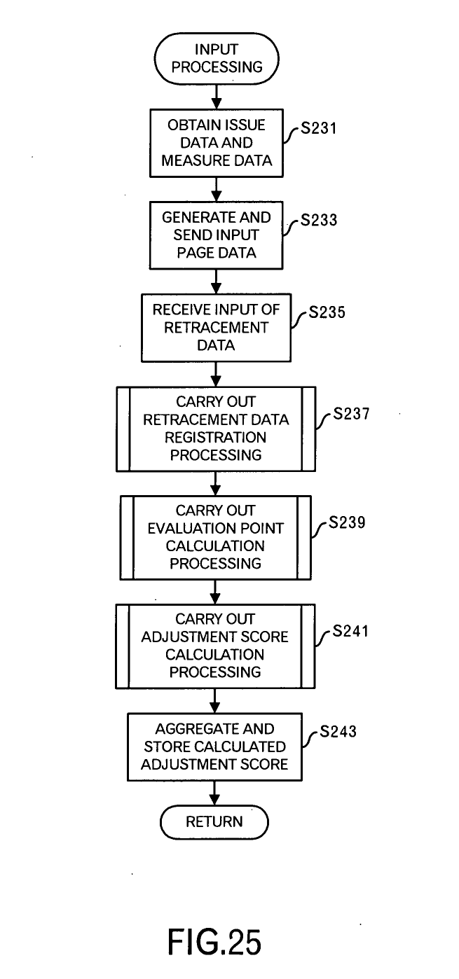

Next, an operation of the system shown in FIG. 16 will be explained by using FIGS. 24 to 43. FIG. 24 shows a main processing flow in this embodiment. First, the input/output processor 91 of the retracement data evaluation apparatus 9 judges whether or not a data input request is received from the user terminal A operated by a member A of a certain project, for example (step S201). When the data input request is received (step S201: Yes route), an input processing is carried out (step S203). The input processing will be explained by using FIGS. 25 to 34. Incidentally, in this embodiment, an input user inputs a combination of the issue and measure, but he or she may input either the issue or the measure.

First, the input/output processor 91 obtains the issue data and the measure data from the retracement data storage 95 (step S231 in FIG. 25). For example, the content of the issue, which is stored in the issue data table shown in FIG. 19, and the content of the measure, which is stored in the measure data table shown in FIG. 20 are obtained. Next, the input/output processor 91 generates input page data by using the obtained issue data and measure data, and transmits the input page data to the user terminal A (step S233). Incidentally, when the volume of the stored issue data and measure data is huge and it is impossible to generate the input page data by using all the issue data and measure data, the narrowing of the obtained issue data and measure data may be carried out. For example, the issue or measure may be sorted in a descending order of the evaluation point or a descending order of the number of reuses to display only the top predetermined number of issues or measures, or the first to third similar case search processing and case narrowing in the first embodiment may be carried out for the issue or measure.

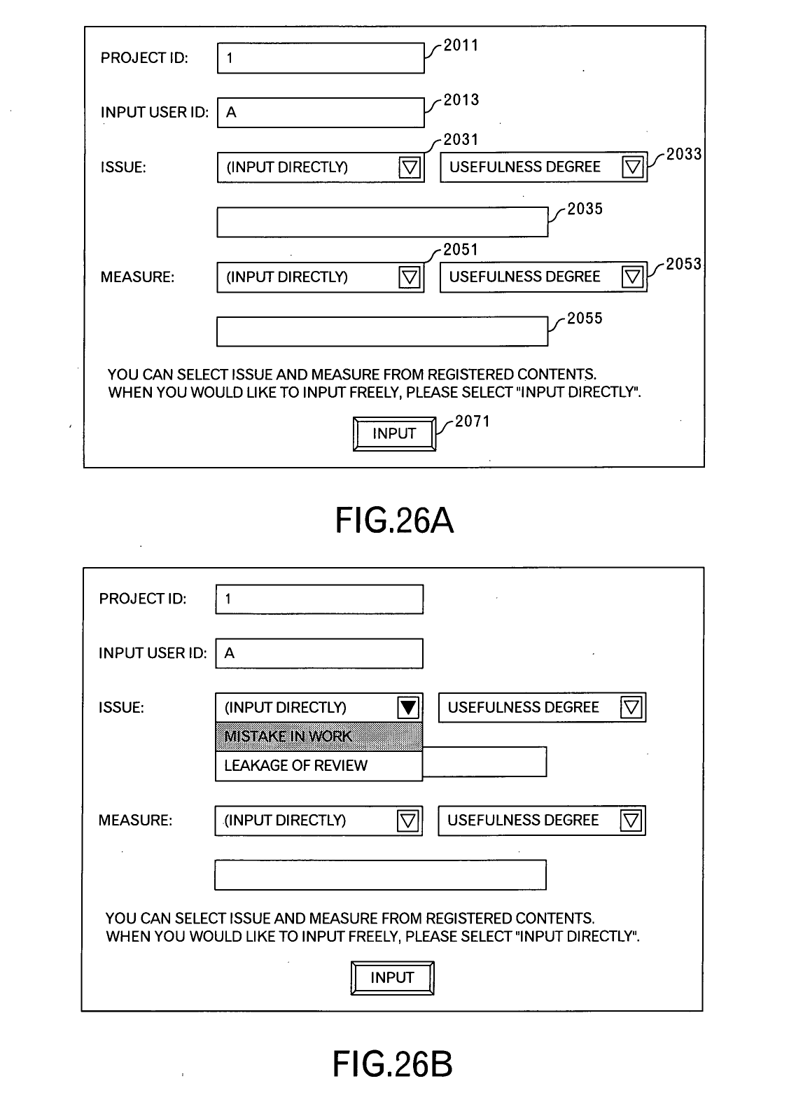

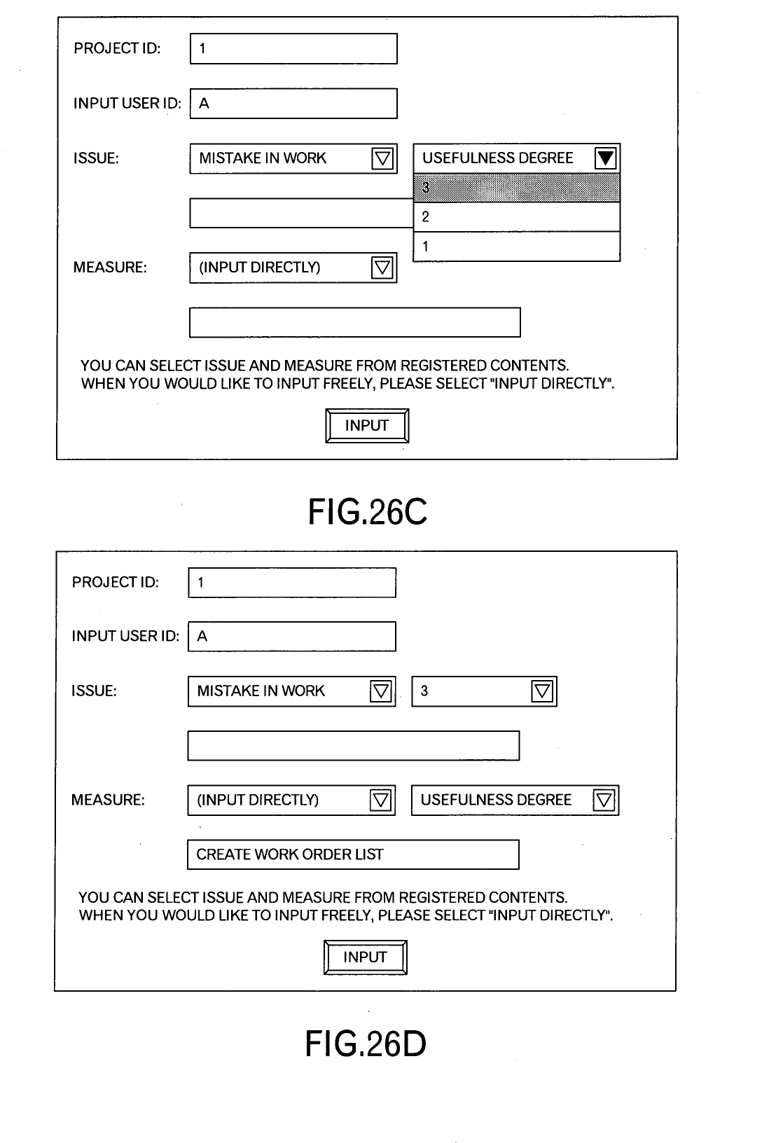

The user terminal A receives the input page data from the retracement data evaluation apparatus 9, and displays the page on a display device. For example, a screen as shown in FIG. 26A is displayed. In an example of FIG. 26A, the screen includes an input column 2011 of the project ID, an input column 2013 of the input user ID, a selection column 2031 of the issue, a selection column 2033 of a usefulness degree of the issue, an input column 2035 of the issue, a selection column 2051 of the measure, a selection column 2053 of the usefulness degree of the measure, an input column 2055 of the measure and an input button 2071. Incidentally, this input page is a mere example, and is not limited to this. For example, when a table to associate the input user ID with the PJID is held, the input column of the project ID is omitted, and the PJID corresponding to the input user ID input to the column of the input user ID may be identified by the input/output processor 91 from such a table. In addition, when an authentication processing is carried out for the input user when receiving the data input request, for example, the input column of the input user ID may be omitted.

Next, a case where the member A of the project reuses an issue, which has already been registered, will be explained by using FIG. 26B. The selection column 2031 of the issue is a combo box, for instance, and includes the contents of the issues obtained from the issue data table (FIG. 19). Here, the member A of the project selects an issue he or she would like to reuse from the issues displayed in the combo box. Incidentally, the selection column 2051 is also a combo box, and includes the contents of the measures obtained from the measure data table (FIG. 20).

Next, a case where the member A of the project scores the selected issue will be explained by using FIG. 26C. The selection column 2033 of the usefulness degree of the issue is a combo box to select the score, for instance. Here, the member A of the project selects a score from the combo box. Incidentally, also when the measure is scored, the member A selects a score from the combo box, which is the selection column 2053 of the usefulness degree of the measure.

The input user cannot only select the content of the issue and the measure from the issues and the measures, which have already been registered, but also separately input them freely. FIG. 26D shows an example of a screen when the member A of the project freely inputs the content of the measure. In addition, the score data may be input into an input column for the score data, which may be provided, instead of selecting the score from the combo box. After that, the member A of the project clicks the input button 2071 to instruct the user terminal A to transmit data concerning the issue and the measure to the retracement data evaluation apparatus 9. The user terminal A accepts the input instruction from the member A of the project, and transmits the data concerning the issue and the measure according to the instruction to the retracement data evaluation apparatus 9. In this embodiment, the PJID, the input user ID, the content of the issue, the score data of the issue, the content of the measure and the score data of the measure are transmitted. Incidentally, when the content of the issue is selected from the issues displayed in the combo box, data representing an issue was selected is transmitted. Data representing a measure was selected is also transmitted when the content of the measure is selected from the measures displayed in the combo box. For example, the issue IDs are obtained at the step S231 in addition to the contents of the issues, and the input page data including the issue ID is generated at the step S233. And, when an issue is selected, the issue ID of the selected issue is transmitted as the data concerning the issue was selected.

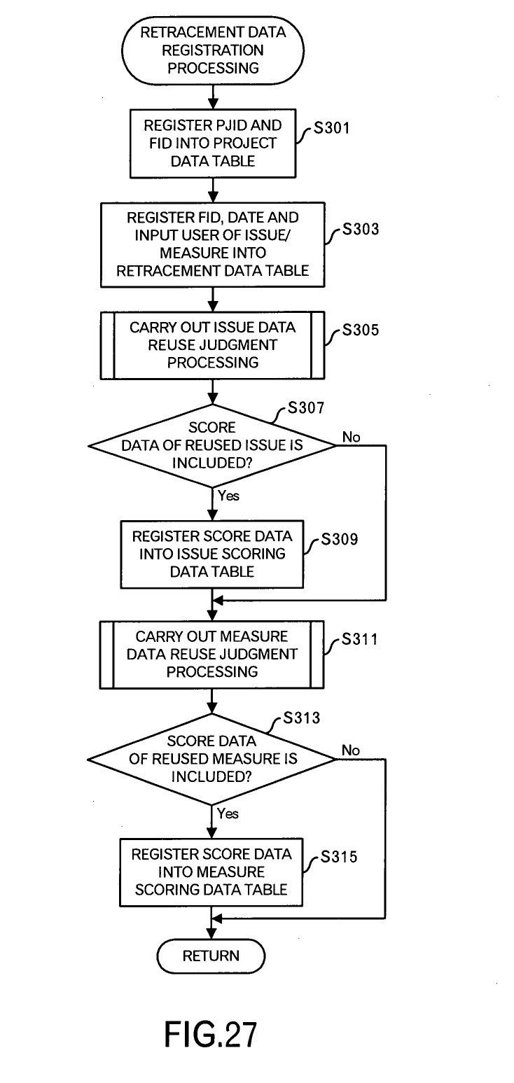

The input/output processor 91 of the retracement data evaluation apparatus 9 receives the aforementioned data from the user terminal A (step S235), and carries out a retracement data registration processing (step S237). The retracement data registration processing will be explained by using FIGS. 27 to 29.

First, the input/output processor 91 issues a new FID, adds a new record into the project data table (FIG. 18), and registers the PJID received from the user terminal A and the newly issued FID (step S301 in FIG. 27). Incidentally, at this timing, the issue evaluation point, the measure evaluation point and the adjustment score are not registered.

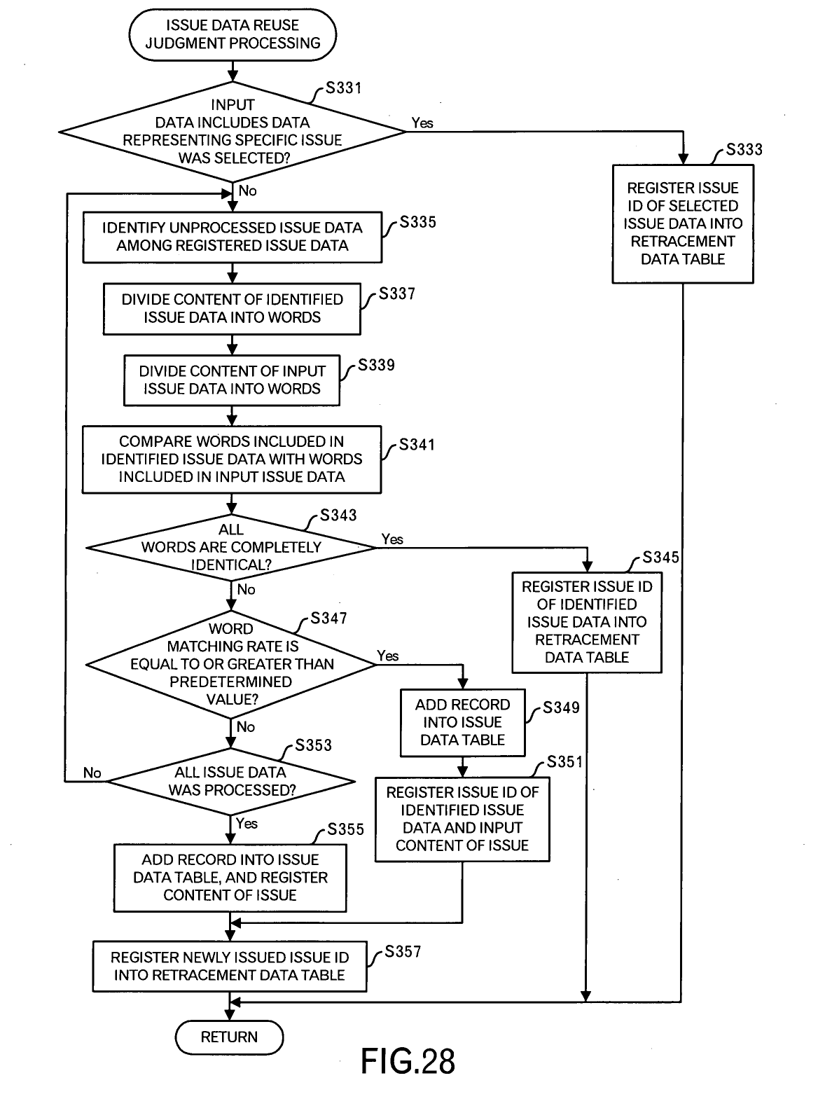

Next, the input/output processor 91 adds a new record into the retracement data table (FIG. 17), and registers a date when the data concerning the issue and the measure was input, the input user ID of the issue and the measure, which were received from the user terminal A, in association with the FID issued at the step S301 (step S303). After that, the input/output processor 91 carries out an issue data reuse judgment processing (step S305). The issue data reuse judgment processing will be explained by using FIG. 28.

First, the input/output processor 91 judges whether or not the data received from the user terminal A includes data representing a specific issue was selected from the issues, which have already been registered into the issue data table (FIG. 19) (step S331 in FIG. 28). When it is judged that the data received from the user terminal A includes the specific issues was selected (step S331: Yes route), the input/output processor 91 judges that the same issue as an issue, which has already been registered, and registers the issue ID of the selected issue into an added record of the retracement data table (FIG. 17).

As a result of the processing at the step S333, a record shown in a line 1701 of FIG. 17 is registered into the retracement data table, for example. In the record shown in the line 1703, the retracement data whose FID is “11” includes the same issue ID as the issue ID of the retracement data whose FID is “2”. That is, it is shown that the content of the issue in the retracement data whose FID is “2” was selected.

When it is judged that the data representing the specific issue was selected is not included (step S331: No route), the input/output processor 91 identifies one record of unprocessed issue data in the issue data table (FIG. 19) (step S335). Then, the input/output processor 91 divides the content of the issue included in the identified issue data into words (step S337), and divides the content of the issue received from the user terminal A into words, similarly (step S339). For example, a well-known morphological analysis technique is used for the word dividing processing. However, any method other than the morphological analysis technique can be adopted.

Then, the input/output processor 91 compares the words included in the content of the identified issue with the words included in the received content of the issue (step S341). When it is judged that all the words are completely identical (step S343: Yes route), the input/output processor 91 judges that the same issue as the identified issue is reused, and registers the issue ID of the identified issue data into an added record of the retracement data table (step S345). Then, the processing shifts to an original processing. Also in the processing at the step S345, a record similar to the record shown in the line 1701 of FIG. 17, for example, is registered in the retracement data table.

When it is judged that the words are not completely identical (step S343: No route), the input/output processor 91 judges whether or not a matching word rate between the content of the identified issue and the received content of the issue is equal to or greater than a predetermined value (step S347). When it is judged that the matching word rate is equal to or greater than the predetermined value (step S347: Yes route), the input/output processor 91 judges that the received issue is not identical with the identified issue, but reuses the identified issue, the input/output processor 91 newly issues an issue ID, and adds a new record in the issue data table (step S349). Then, the input/output processor 91 registers the received content of the issue, and registers the issue ID of the identified issue as the issue ID of the reused issue into the added record of the issue data table (step S351). After that, the processing shifts to step S357, and the input/output processor 91 registers the newly issued issue ID into the added record of the retracement data table. Then, the processing returns to the original processing.

As a result of the processing at the steps S349 and S357, a record shown in, for example, a line 1711 of FIG. 17 is registered into the retracement data table. As a result of the processing at the step S351, a record shown in, for example, a line 1901 of FIG. 19 is registered into the issue data table. In the record shown in the line 1901, the issue data whose issue ID is “3” represents that “2” is registered as an ID of the reused issue, that is, that the issue data whose issue ID is “2” is reused. The content of the issue whose issue ID is “3” is “lack of communication in the team”, and the content of the issue whose issue ID is “2” is “lack of communication with the customer”. That is, because the issue of the issue ID “3” and the issue of the issue ID “2” are not completely identical but it is judged that the matching word rate is equal to or greater than the predetermined value, it is judged that the issue of the issue ID “3” reuses the issue of the issue ID “2”.

When it is judged that the matching word rate between the content of the identified issue and the received content of the issue is less than the predetermined value (step S347: No route), the input/output processor 91 judges whether or not all the issue data registered in the issue data table have been processed (step S353). When it is judged that there is unprocessed issue data (step S353: No route), the processing returns to the step S335 to repeat the aforementioned processing. On the other hand, when it is judged that all the issue data have been processed (step S353: Yes route), the input/output processor 91 judges that the received issue is not the same as the already registered issue, and does not reuse the already registered issues, and adds a new record into the issue data table, issues a new issue ID, and registers the received content of the issue (step S355). After that, the input/output processor 91 registers the newly issued issue ID into the added record of the retracement data table (step S357), and the processing returns to the original processing.

By carrying out the aforementioned processing, the reuse of the issue is judged in the received retracement data received from the user terminal A, and when the issue is reused, data indicating that the issue was reused is registered into the retracement data table or the issue data table.

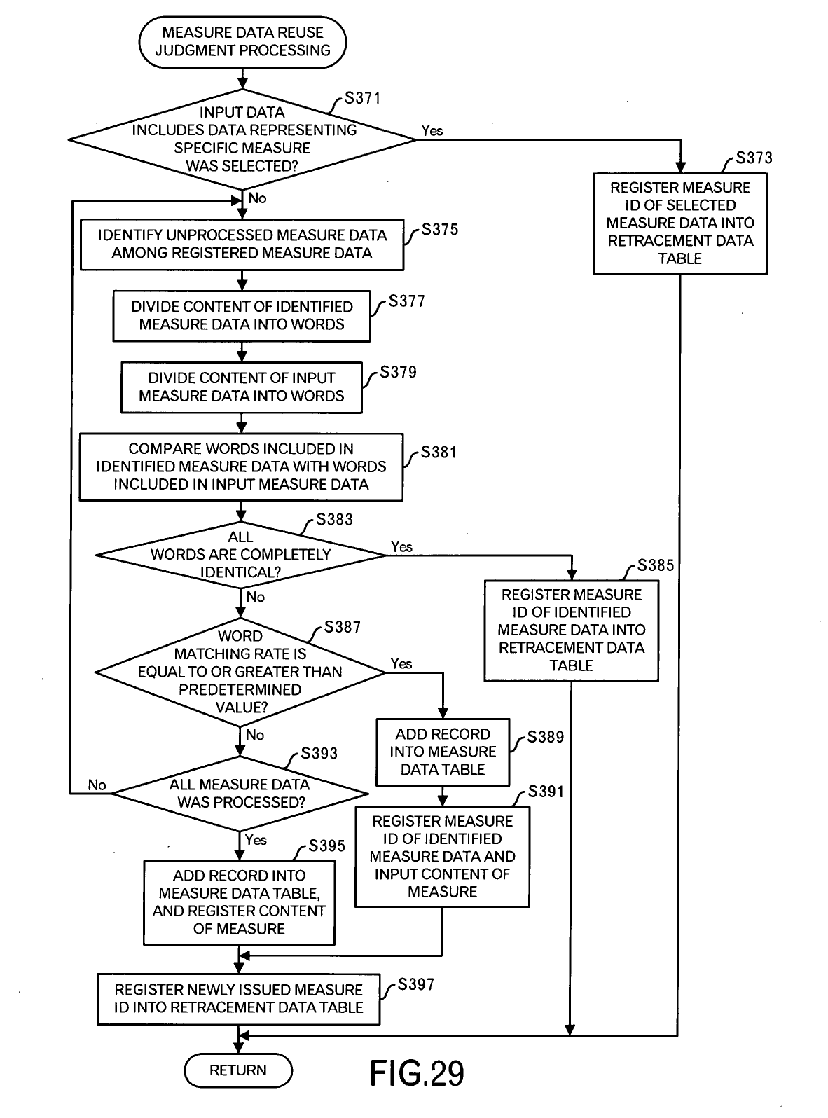

Then, returning to the explanation of FIG. 27, the input/output unit 91 judges whether or not the received data includes score data of the reused issue (step S307). When it is judged that the score data is included (step S307: Yes route), the input/output processor 91 registers the issue ID of the reused issue, which was registered into the issue data table (FIG. 19), the PJID received from the user terminal A, the FID issued at the step S301, and the score data into the issue scoring data table (FIG. 21) (step S309). On the other hand, when it is judged that the score data is not included (step S307: No route), or after the step S309, the input/output processor 91 carries out a measure data reuse judgment processing (step S311). The measure data reuse judgment processing will be explained by using FIG. 29.

First, the input/output processor 91 judges whether or not the data received from the user terminal A includes the data representing a specific measure was selected among the measures, which have already been registered into the measure data table (FIG. 20) (step S371 in FIG. 29). When it is judged that the data representing the specific measure was selected (step S371: Yes route), the input/output processor 91 judges that the same measure as the already registered measure is reused, and registers the measure ID of the selected measure into an added record of the retracement data table (FIG. 17), and the processing returns to the original processing.

When it is judged that the data representing the specific measure was selected is not included (step S371: No route), the input/output processor 91 identifies one record of unprocessed measure data in the measure data table (step S375). Then, the input/output processor 91 divides the content of the measure, which is included in the identified measure data, into words (step S377), and divides the content of the measure, which is received from the user terminal A, similarly (step S379). The word dividing processing is as described above.

Then, the input/output processor 91 compares the words included in the content of the identified measure and words included in the received content of the measure (step S381). When it is judged that all the words are completely identical (step S383: Yes route), the input/output processor 91 judges that the same measure as the identified measure is reused, and registers the measure ID of the identified measure data into the added record of the retracement data table (step S385), and the processing returns to the original processing.

When it is judged that the words are not completely identical (step S383: No route), the input/output processor 91 judges whether or not a matching word rate between the content of the identified measure and the receive content of the measure is equal to or greater than a predetermined value (step S387). When it is judged that the word matching rate is equal to or greater than the predetermined value (step S387: Yes route), the input/output processor 91 judges that the received measure is not the same as the identified measure, but reuses the identified measure, and the input/output processor 91 newly issues a measure ID, and adds a new record into the measure data table (step S389). Then, the input/output processor 91 registers the received content of the measure, and registers the measure ID of the identified measure as the measure ID of the reused measure into the added record in the measure data table (step S391). After that, the processing shifts to step S397.

When it is judged that the word matching rate between the content of the identified measure and the received content of the measure is less than the predetermined value (step S387: No route), the input/output processor 91 judges whether or not all of the measure data registered in the measure data table have been processed (step S393). When it is judged that there is unprocessed measure data (step S393: No route), the processing returns to the step S375 and the aforementioned processing is repeated. On the other hand, when it is judged that all of the measure data have been processed (step S393: Yes route), the input/output processor 91 judges that the received measure is not the same as the measure, which has already been registered, and does not reuse the measures, which have already been registered, and the input/output processor 91 adds a new record into the measure data table, issues a new measure ID, and registers the received content of the measure (step S395). After that, the input/output processor 91 registers the newly issued measure ID into the added record of the retracement data table (step S397), and the processing returns to the original processing.

By carrying out the aforementioned processing, in the retracement data received from the user terminal A, it is judged whether or not the measure is reused, and when the measure was reused, the data representing the measure was reused is registered into the retracement data table or measure data table.

Returning to the explanation of FIG. 27, the input/output processor 91 judges whether or not the received data includes score data of the used measure (step S313). When it is judged that the score data is included (step S313: Yes route), the input/output processor 91 registers the measure ID of the reused measure, which was registered into the measure data table (FIG. 20), the PJID received from the user terminal A, the FID issued at the step S301, and the score data into the measure scoring data table (FIG. 22) (step S315). On the other hand, when it is judged that the score data of the measure is not included (step S313: No route), or after the step S315, the processing returns to the original processing.

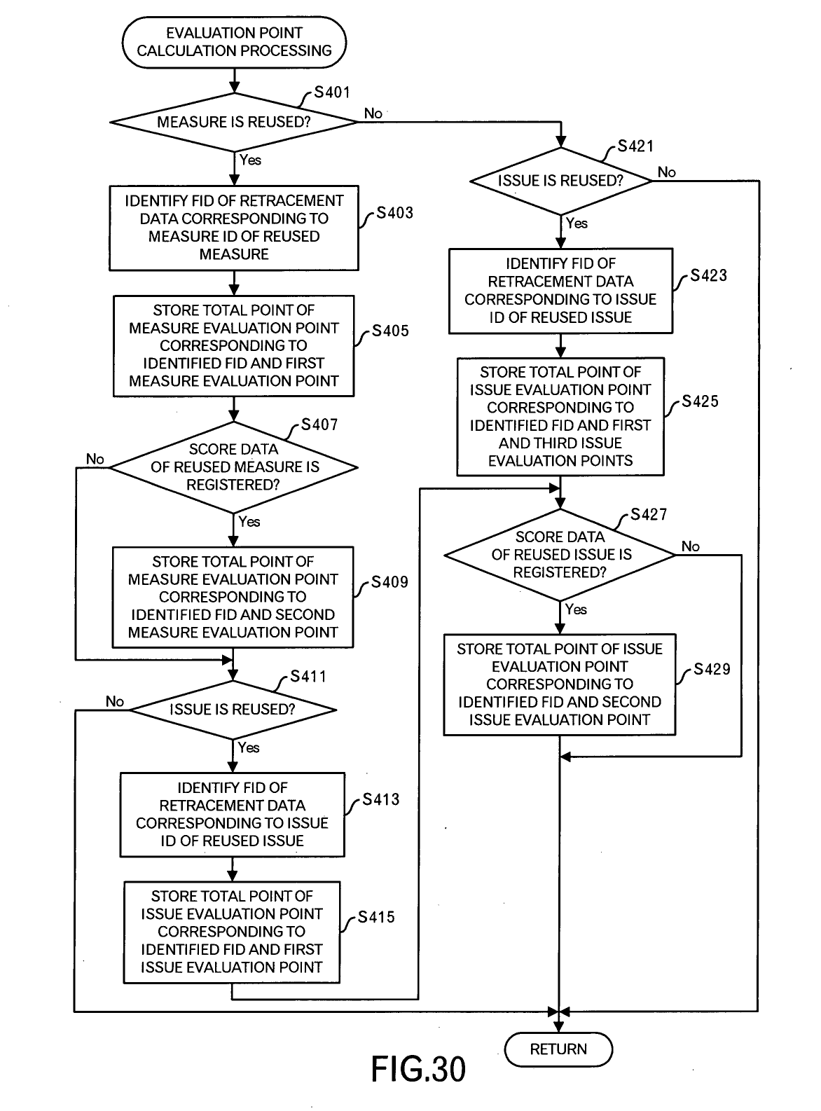

Returning to the processing of FIG. 25, the evaluation data calculation processor 93 carries out an evaluation calculation processing by using the retracement data registered in the retracement data registration processing as the retracement data to be considered in order to recalculate an issue evaluation point and measure evaluation point of the retracement data, which has already been registered (step S239). Incidentally, as shown in FIG. 18, as for the retracement data, which has already been registered, the issue evaluation point and the measure evaluation point, which were previously calculated, have already been stored in the project data table. In addition, in this embodiment, the issue evaluation point and the measure evaluation point, which have been stored in the project data table, are points including the adjustment score, which is described in detail later. The evaluation point calculation processing will be explained by using FIG. 30.

First, the evaluation data calculation processor 93 refers to the retracement data table (FIG. 17) or the measure data table (FIG. 20) to judge whether or not the measure is reused in the retracement data to be considered (step S401 in FIG. 30). As described in the measurement reuse judgment processing, when the measure is reused, the same measure ID as the measure ID corresponding to another FID is registered in the retracement table, or the measure ID of the reused measure is registered in the measure data table.

When it is judged that the measure is reused (step S401: Yes route), the evaluation data calculation processor 93 refers to the retracement data table to identify the FID of the retracement corresponding to the measure ID of the reused measure (step S403). When plural records of retracement data corresponding to the measure ID of the reused measure are registered, the FID of the retracement data, which was registered earliest, is identified, for example. Next, the evaluation data calculation processor 93 refers to the project data table to extract the measure evaluation point corresponding to the identified FID, and stores a point obtained by totaling up the extracted measure evaluation point and a first measure evaluation point as a new measure evaluation point corresponding to the identified FID into the project data table (step S405). For example, in a case where the first measure evaluation point is “10”, when it is judged that the measure of the retracement data to be considered reuses the measure A, the measure evaluation point of the measure A increases by “10” points. By repeating such a processing every time the retracement data is registered, it is possible to increase the evaluation point of the reused measure according to the number of times the measure is reused.

Next, the evaluation data calculation processor 93 refers to the measure scoring data table (FIG. 22) to judge whether or not the score data of the reused measure is registered in association with the retracement data to be considered (step S407). When the score data of the reused measure is registered, the FID of the retracement data to be considered is stored in the measure scoring data table in association with the measure ID of the reused measure. When it is judged that the score data is registered (step S407: Yes route), the evaluation data calculation processor 93 calculates a second measure evaluation by using the score data, totals up the measure evaluation point corresponding to the identified FID and the second measure evaluation point, and stores the totaled point as the new measure evaluation point corresponding to the identified FID into the project data table (step S409). The second measure evaluation point is calculated by multiplying a point of the score data by, for example, “5”. By repeating such a processing every time the retracement data is registered, the score data corresponding to the reused measure can be reflected to the evaluation point of the reused measure.

When it is judged that the score data is not registered (step S407: No route), or after the step S409, the evaluation data calculation processor 93 refers to the retracement data table or the issue data table (FIG. 19), to judge whether or not the issue is reused in the retracement data to be considered (step S411). Similarly to the case where the measure is reused, when the issue is reused, the same issue ID as the issue ID corresponding to another FID is registered in the retracement data table or the issue ID of the reused issue is registered in the issue data table. When it is judged that the issue is not reused (step S411: No route), the processing returns to the original processing.

On the other hand, when it is judged that the issue is reused (step S411: Yes route), the evaluation data calculation processor 93 refers to the retracement data table to identify the FID of the retracement data corresponding to the issue ID of the reused issue (step S413). Similarly to the case of the measure, when plural records of the retracement data corresponding to the issue ID of the reused issue are registered, the FID of the retracement data, which was registered earliest, for example, is identified. Next, the evaluation data calculation processor 93 refers to the project data table to extract the issue evaluation point corresponding to the identified FID, totals up the extracted issue evaluation point and a first issue evaluation point, and stores the totaled point as a new issue evaluation point corresponding to the identified FID into the project data table (step S415). For example, in a case where the first issue evaluation point is “10”, when it is judged that the issue of the retracement data to be considered reused the issue A, and it is judged that the measure of the retracement data to be considered reused other measure, the issue evaluation point of the issue A increases by “10” points. By repeating such a processing every time the retracement data is registered, the evaluation point of the reused issue can be increased according to the number of times the issue is reused. After that, the processing shifts to the step S427.

On the other hand, when it is judged that the measure is not reused (step S401: No route), the evaluation data calculation processor 93 refers to the retracement data table or the issue data table to judge whether or not the issue is reused (step S421). When it is judged that the issue is not reused (step S421: No route), the processing returns to the original processing.

When it is judged that the issue is reused (step S421: Yes route) it is considered that, by registering a new measure for the reused issue, the number of measures registered for the issue is increased. In such a case, the evaluation data calculation processor 93 refers to the retracement data table to identify the FID of the retracement data corresponding to the issue ID of the reused issue (step S423). Next, the evaluation data calculation processor 93 refers to the project data table to extract the issue evaluation point corresponding to the identified FID, totals up the extracted issue point, the first issue evaluation point and a third evaluation point, and stores the totaled point as a new issue evaluation point corresponding to the identified FID into the project data table (step S425). For example, as described above, in a case where the first issue evaluation point is “10” and the third issue evaluation point is “15”, when it is judged that the issue of the retracement data to be considered reused the issue A, and it is judged that the measure of the retracement data to be considered did not reuse other measure, the issue evaluation point of the issue A is increased by “25” points. By repeating such a processing every time the retracement data is registered, it is possible to increase the issue evaluation point according to the number of measures registered for the issue.

Next, the evaluation data calculation processor 93 refers to the issue scoring data table (FIG. 21) to judge whether or not the score data of the reused issue is registered in association with the retracement data to be considered (step S427). Similarly to the case of the score data of the measure, when the score data of the reused issue is registered, the FID of the retracement data to be considered is stored in association with the issue ID of the reused issue, for example. When it is judged that score data is registered (step S427: Yes route), the evaluation data calculation processor 93 calculates a second issue evaluation point by using the score data, totals up the issue evaluation point corresponding to the identified FID and the second issue evaluation points, and stores the totaled point as the new issue evaluation point corresponding to the identified FID into the project data table (step S429). The second issue evaluation point is calculated by multiplying a point of the score data by “5”, for example, similarly to the second measure evaluation point. By repeating such a processing every time the retracement data is registered, it is possible to reflect the score data for the reused issue to the evaluation point of the reused issue. When it is judged that the score data is not registered (step S427: No route), or after the step S429, the processing returns to the original processing.

By carrying out the aforementioned processing, the evaluation point of other issue or measure is recalculated based on the data concerning the received issue and measure.

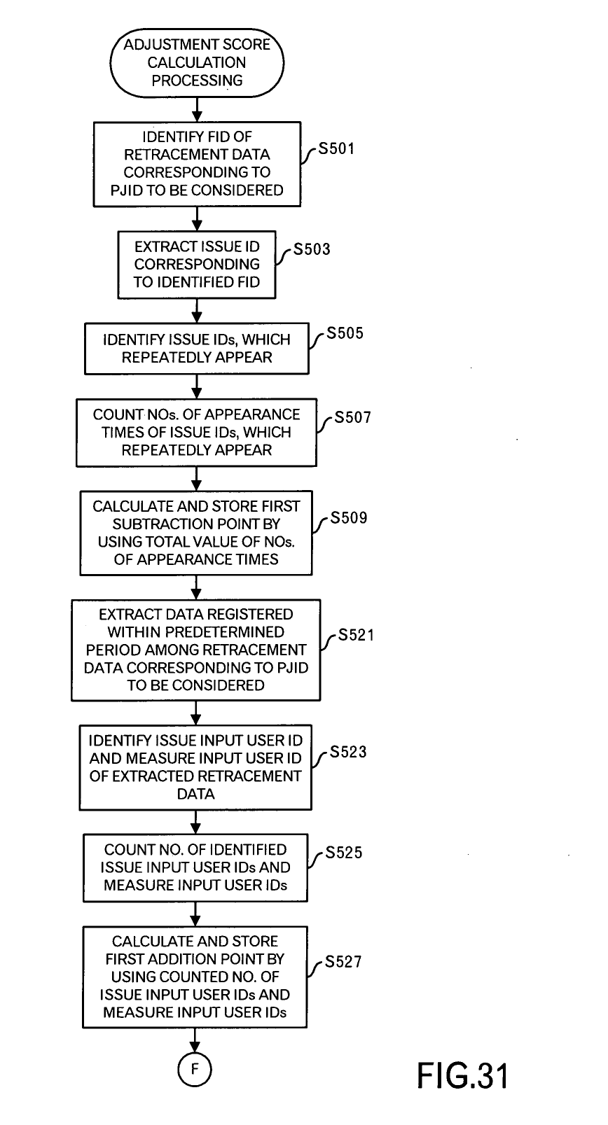

Returning to the processing of FIG. 25, the evaluation data calculation processing 93 carries out an adjustment score calculation processing by using the received PJID as the PJID to be considered (step S241). The adjustment score calculation processing will be explained by using FIGS. 31 to 33.

First, the evaluation data calculation processor 93 refers to the project data table (FIG. 18) to identify the FID of the retracement data corresponding to the PJID to be considered (step S501 in FIG. 31). Next, the evaluation data calculation processor 93 refers to the retracement data table (FIG. 17) to extract the issue IDs corresponding to the identified FID (step S503). Then, the evaluation data calculation processor 93 identifies the issue IDs, which repeatedly appear, among the extracted issue IDs (step S505), and counts the total number of appearance times of the issue IDs, which repeatedly appear (step S507). For example, as a result of extracting the issue IDs of all the retracement data for the PJID to be considered, it is assumed that the issue ID “2” appears three times, the issue ID “3” appears twice, and other issue IDs respectively appear only once. In this case, the total number of appearance times, which is counted at the step S507, is “5” (=3+2).

Then, the evaluation data calculation processor 93 calculates a first subtraction point by using the total number of appearance times, which is counted at the step S507, and stores the first subtraction point into a storage device such as a main memory (step S509). In this embodiment, the first subtraction point is calculated by multiplying the total number of appearance times by “10”, for example. In the aforementioned example, the first subtraction point is “50”.

In the project in which the same issue is repeatedly registered, because the retracement data evaluation apparatus 9 is not effectively utilized, it is considered that the same failure is repeated. Then, by decreasing the evaluation point of such a project, it is possible to urge the executive in charge of the project to pay attention.

Incidentally, in this embodiment, although attention is paid to the number of appearance times of the issue IDs, which repeatedly appear, the first subtraction point may be calculated by paying attention to the number of types of the issue IDs, which repeatedly appear. In the aforementioned example, because the issue IDs “2” and “3” are extracted, the number of types of the issue IDs, which repeatedly appear, is “2”. In this case, by multiplying the number of types of the issued ID, which repeatedly appear, by, for example, “10”, the first subtraction point becomes “20”.

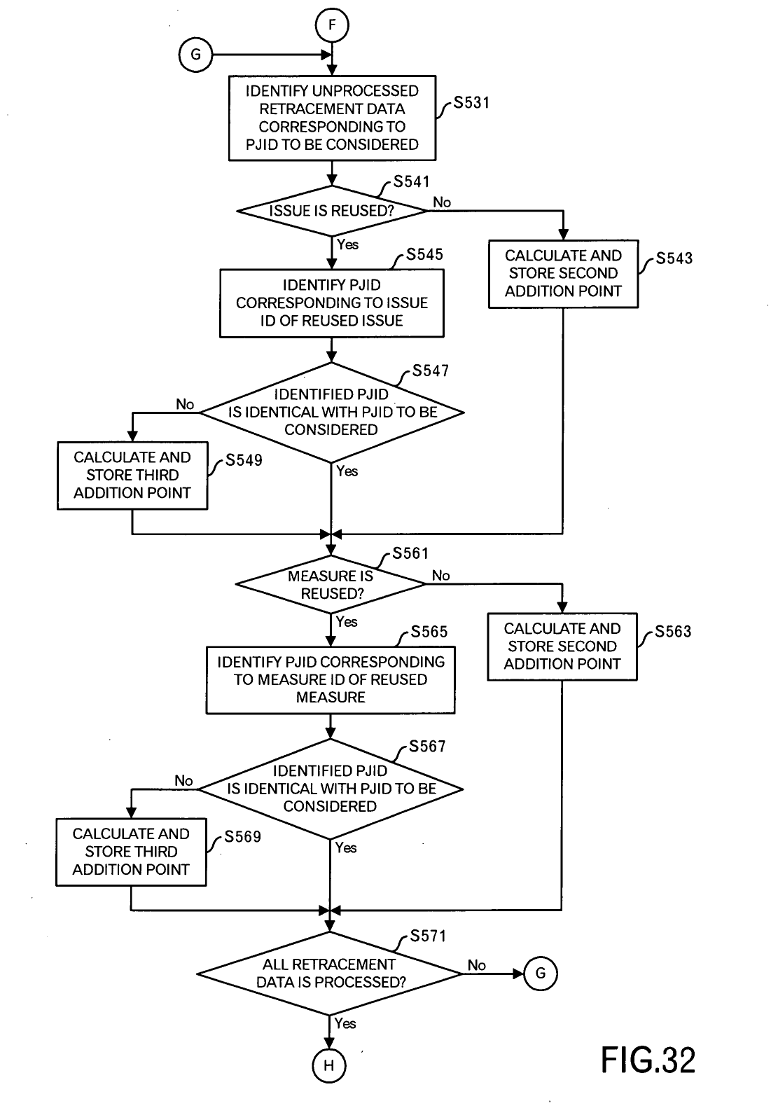

Next, the evaluation data calculation processor 93 extracts the retracement data, which was registered within a predetermined period before the adjustment score calculation processing is carried out, among the retracement data corresponding to the PJID to be considered (step S521). In this embodiment, only the retracement data is extracted, which was registered within one past week before the adjustment score calculation processing is carried out, for example. Then, the evaluation data calculation processor 93 identifies the issue input user IDs and measure input user IDs, which are included in the extracted retracement data (step S523). After that, the evaluation data calculation processor 93 counts the number of the identified issue input user IDs and measure input user IDs (step S525), calculates a first addition point, and stores the calculated first addition point into the storage device such as the main memory (step S527). The first addition point is calculated by dividing the number of the identified issue input user IDs and measure input user IDs by the number of members in the project to obtain a rate of speakers, and multiplying the rate of speakers by the number of records of the retracement data, which was registered within the predetermined period, and “5”. For example, it is assumed that the number of members in the project of the PJID to be considered is “10”, the number of records of the retracement data, which corresponds to the PJID to be considered and was registered within one week, is “8”, the identified issue input user IDs are “1, 3, and 6”, and the identified measure input user IDs are “1, 2, 3 and 8”. In this case, the number of identified issued input user IDs and measure input user IDs (i.e. the number of kinds of the identified issued input user IDs and measure input user IDs) is “5”, which is composed of the IDs “1, 2, 3, 6 and 8”, and the rate of speakers is “0.5” (=5/10). Then, the first addition point is calculated as “20” (=0.5*8*5). After that, the processing shifts to FIG. 32 via a terminal F.

By adding the evaluation point according to the number of input user IDs, it is possible to raise the evaluation point of the project in which a lot of users register the retracement data, compared with the evaluation point of other projects, in which only a portion of members registers the retracement data. Incidentally, similarly to the processing for calculating the first subtraction point, instead of paying attention to the number of issue input user IDs and measure input user IDs, the first addition point may be calculated by paying attention to the number of issues and the number of measures, which correspond to each input user IDs. For example, even when the rate of speakers and the number of records of the retracement data are the same in both cases, it is possible to raise the first addition point in a case where all of the members evenly register the retracement data, compared with a case where a portion of members does not register the retracement data.

Next, the evaluation data calculation processor 93 identifies one record of the unprocessed retracement data among the retracement data corresponding to the PJID to be considered (step S531 in FIG. 32). Then, the evaluation data calculation processor 93 judges whether or not another issue is reused in the issue of the identified record of the retracement data as the issue to be considered (step S541). Incidentally, as described below, the processing from the step S541 to S569 is repeated until all the retracement data corresponding to the PJID to be considered is completely processed.

When it is judged that the issue to be considered does not reuse another issue (step S541: No route), the evaluation data calculation processor 93 judges that a new issue is registered, calculates a second addition point (=(the second addition point immediately before)+10), and stores the second addition point into the memory such as the main memory (step S543). In this embodiment, the initial value of the second addition point is “0”, and when it is judged that another issue is not reused in the issue to be considered, the second addition point increases by “10” points. After that, the processing shifts to the step S561.

On the other hand, when it is judged that another issue is reused (step S541: Yes route), the evaluation data calculation processor 93 identifies the PJID corresponding to the issue ID of the reused issue in the issue to be considered by using the retracement data table (FIG. 17) and the project data table (FIG. 18) (step S545). Next, the evaluation data calculation processor 93 judges whether or not the identified PJID is identical with the PJID to be considered (step S547). When it is judged that the identified PJID is not identical (step S547: No route), the evaluation data calculation processor 93 judges that the issue, which was registered by another project, is reused, calculates a third addition point (=(the third addition point immediately before)+6), and stores the third addition point into the storage device such as the main memory (step S549). In this embodiment, similarly to the second addition point, the initial value of the third addition point is also “0”, and when it is judged that the issue to be considered reuses the issue registered by another project, the third addition point increases by “6” points. After that, the processing shifts to the step S561.

When it is judged that the PJID is identical (step S547: Yes route), or after the step S543 or S549, the evaluation data calculation processor 93 judges whether or not another measure is reused in the identified measure of the retracement data as the measure to be considered (step S561). When it is judged that another measure is not reused (step S561: No route), the evaluation data calculation processor 93 judges that a new measure is registered, calculates the second addition point (=(the second point immediately before)+10) and stores the second addition point into the storage device such as the main memory (step S563). The second addition point is increased by “10” points every time the new measure is registered, for example. After that, the processing shifts to the step S571.

On the other hand, when it is judged that the measure is reused (step S561: Yes route), the evaluation data calculation processor 93 identifies the PJID corresponding to the measure ID of the reused measure by using the retracement data table (FIG. 17) and the project data table (FIG. 18) (step S565). Next, the evaluation data calculation processor 93 judges whether or not the identified PJID is identical with the PJID to be considered (step S567). When it is judged that the PJID is not identical (step S567: No route), the evaluation data calculation processor 93 judges that the measure in another project is reused, calculates the third addition point (=(the third addition point immediately before)+6), and stores the third addition point into the storage device such as the main memory (step S569). The third addition point is increased by “6” points every time the measure of another project is reused. After that, the processing shifts to the step S571.

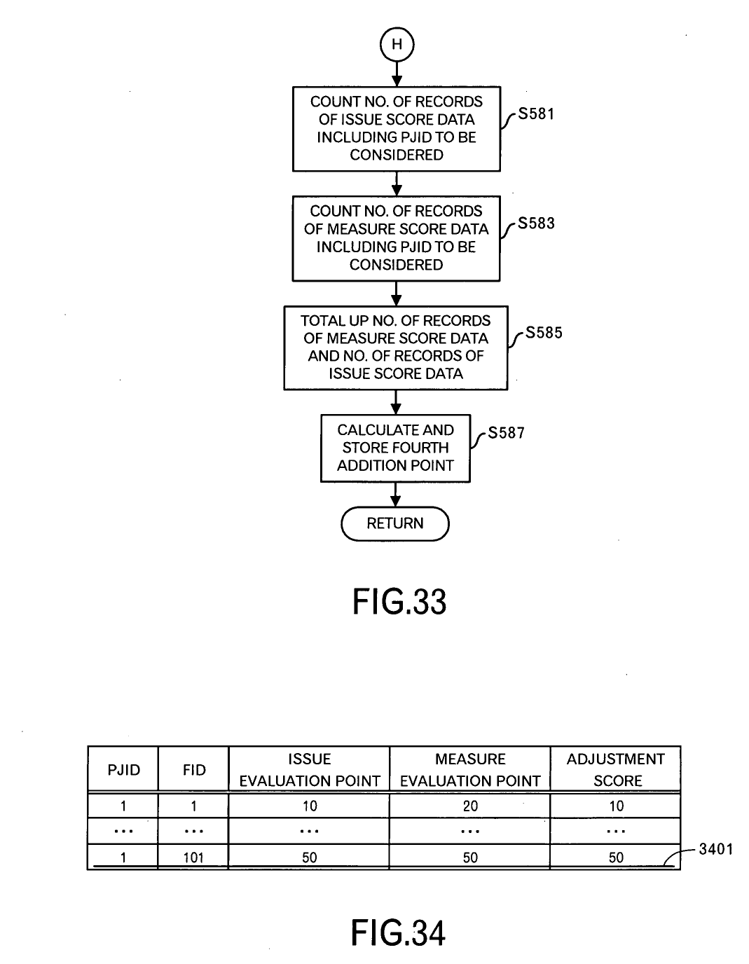

When it is judged that the PJID is identical (step S567: Yes route), or after the step S563 or S569, the evaluation data calculation processor 93 judges whether or not all the retracement data corresponding to the PJID to be considered have been processed (step S571). When unprocessed retracement data is remained (step S571: No route), the processing returns to the step S531 via a terminal G. On the other hand, when all the retracement data have been processed (step S571: Yes route), the processing shifts to a processing in FIG. 33 via a terminal H.

By using the second addition point, it is possible to raise the evaluation point for the project, which registered the new issue or measure. In addition, by using the third addition point, it is possible to raise the evaluation point for the project, which effectively utilizes the issue or measure registered by other projects, when the retracement data is registered.

Next, the evaluation data calculation processor 93 refers to the issue scoring data table (FIG. 21) to count the number of records including the PJID to be considered (step S581 in FIG. 33). Similarly, the evaluation data calculation processor 93 refers to the measure scoring data table (FIG. 22) to count the number of records including the PJID to be considered (step S583). Then, for example, the evaluation data calculation processor 93 totals up the number of records, which was counted in the issue scoring data table, and the number of records, which was counted in the measure scoring data table (step S585), and further multiplies the totaled value by a predetermined value (e.g. “3”) to obtain a fourth addition point, and stores the fourth addition point into the storage device such as the main memory (step S587). Then, the processing returns to the original processing. By carrying out such a processing, it is possible to raise the evaluation point for the project, which actively scores already existing issues or measures.

Returning to the processing of FIG. 25, the evaluation data calculation processor 93 totals up the first to fourth addition points, which were calculated at the step S241 and stored in the storage device such as the main memory, and subtracts the first subtraction point from the totaled points to obtain an adjustment score of the project when the retracement data was registered at the step S237, and stores the obtained adjustment score into the project data table (FIG. 18) in association with the FID of the retracement data registered at the step S237 (step S243). In this embodiment, in order to reflect the adjustment score to the issue evaluation point and the measure evaluation point of the retracement data, the adjustment score of the project is stored in association with the FID of the retracement data. Then, the processing returns to the original processing.

FIG. 34 shows an example of data registered in the project data table in the input processing. In the record shown in a line 3401 of FIG. 34, the adjustment score calculated at the step S243 is registered in a column of the adjustment score in the project data table. In addition, as described above, a total point value calculated by totaling up the issue evaluation value and the adjustment score is registered in the column of the issue evaluation point. However, when the retracement data was registered, the issue of the retracement data is not reused, and the issue evaluation point is “0”. Thus, as indicated in the line 3401 of FIG. 34, the point value calculated at the step S243 itself is registered into the column of the issue evaluation point. The column of the measure evaluation point is the same. In the input processing, by calculating the adjustment score of the project, which registered the retracement data, and registering the adjustment score as the issue evaluation point and measure evaluation point of the retracement data into the project data table, the evaluation point of the retracement data can be appropriately displayed even when a display processing described later is carried out before an update processing also described later after the registration of the retracement data.

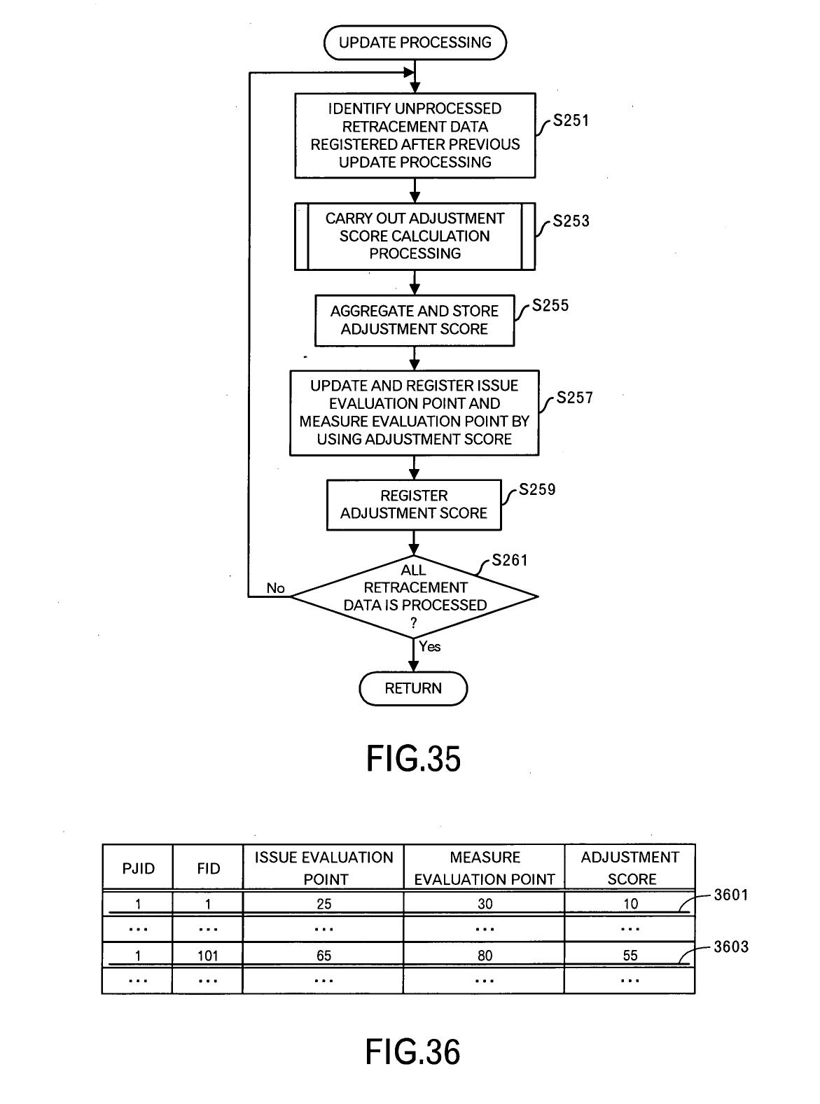

Returning to the processing of FIG. 24, when it is judged that any data input request is not received (step S201: No route), or after the step S203, the evaluation data calculation processor 93 judges whether or not it is a predetermined time (step S211). When it is judged that it is the predetermined time (step S211: Yes route), the evaluation data calculation processor 93 carries out the update processing (step S213). Although the adjustment score is registered when the input processing is carried out as described above, the adjustment score of the retracement data, which has already been registered, is not changed even when other retracement data is registered by the same project after the input processing. Therefore, in this embodiment, in order to reflect the adjustment score calculated based on utilization states of the retracement data in the entire project at a time when one day ends, to the evaluation of all the retracement data, which was registered by the specific project in that day, the update processing is carried out at 0:00 AM everyday. The update processing will be explained by using FIGS. 35 and 36.

First, the evaluation data calculation processor 93 refers to the column of FID and the column of date in the retracement data table (FIG. 17) to identify one record of the unprocessed retracement data as the retracement data to be considered among the retracement data, which was registered after the previous update processing (step S251 in FIG. 35). In a case where the update processing is carried out everyday like this embodiment, the retracement data in which the date of the previous day of the update date is registered, is identified, for example. The reason why only the retracement data in the previous day of the update date is to be considered is because the utilization states of the retracement data by the project in the day when the retracement data was registered cannot be reflected to the evaluation point of the project if the adjustment score is updated in the retracement data, which was registered before the previous day of the update date.

Next, the evaluation data calculation processor 93 carries out the adjustment score calculation processing by using the PJID of the retracement data as the PJID to be considered (step S253). The details of the adjustment score calculation processing (FIGS. 31 to 33) are as described above. After that, the evaluation data calculation processor 93 totals up the first to fourth addition point calculated at the step S253, and subtracts the first subtraction point from the totaled point to obtain the adjustment score of the project, and stores the adjustment score into the storage device such as the main memory (step S255). Next, the evaluation data calculation processor 93 updates the issue evaluation point and measure evaluation point of the retracement data to be considered by using the adjustment score of the project, and stores the updated points into the project data table in association with the FID of the retracement data to be considered (step S257). As described above, in this embodiment, a total point calculated by totaling up the issue evaluation point of the retracement data and the adjustment score, which was calculated in the input processing and was registered in the column of the adjustment score in the project data table, has already been registered in the column of the issue evaluation point in the project data table. Therefore, at the step S257, a point value calculated by subtracting the point value registered in the column of the adjustment score in the project data table in association with the FID of the retracement data to be considered from the point value registered in the column of the issue evaluation point in the project data table, and further adding the adjustment score of the project, which was stored in the storage device such as the main memory at the step S255 to the subtraction result is overwritten into the issue evaluation point of the project data table. The similar processing is carried out for the measure evaluation point. After that, the evaluation data calculation processor 93 overwrites the adjustment score of the project, which was stored into the storage device such as the main memory at the step S255, into the column of the adjustment score in the project data table in association with the FID of the retracement data to be considered (step S259).

Then, the evaluation data calculation processor 93 judges whether or not all of the retracement data have been processed (step S261). When there is unprocessed retracement data (step S261: No route), the processing returns to the step S251. On the other hand, when all of the retracement data have been processed (step S261: Yes route), the processing returns to the original processing.

An example where the retracement data registered in the input processing is updated in the update processing is shown in FIG. 36. In the record shown in a line 3601 of FIG. 36, the retracement data registered on the date before the previous update processing is shown. Therefore, because the adjustment score calculation processing at the step S253 is not carried out, the adjustment score does not change, compared with FIG. 34. However, as a result of the reuse by other issues and measures, the issue evaluation point is increased by “15” points, and the measure evaluation point is increased by “10” points, compared with FIG. 34. On the other hand, in the record shown in a line 3603 of FIG. 36, the retracement data registered after the previous update processing was carried out is shown. Therefore, as a result of carrying out the adjustment score calculation processing at the step S253, the adjustment score of the project is increased by “5” points, compared with FIG. 34. In addition, because the issue and measure were reused after the registration of the retracement data, the issue evaluation point is increased by “10” points, and the measure evaluation point is increased by “25” points, compared with FIG. 34. As a result, compared with the record shown in the line 3401 of FIG. 34, the point value registered in the column of the issue evaluation point is increased by “15” points, and the point value registered in the column of the measure evaluation point is increased by “30” points.

Incidentally, in this embodiment, because the evaluation calculation processing is carried out every time the retracement data is registered in the input processing, and the latest issue evaluation point and measure evaluation point are registered in the project data table at a time when the update processing is carried out, there is no need to carry out the evaluation point calculation processing in the update processing. However, it is possible to carry out the evaluation point calculation processing in the update processing, without carrying out the evaluation point calculation processing (step S239 in FIG. 25) in the input processing. In such a case, only the retracement data registered after the previous update processing was carried out may be processed in the evaluation point calculation processing, and all the retracement data may be processed in the evaluation point calculation processing after initializing the issue evaluation point and measure evaluation point, which were registered in the project data table. When initializing the issue evaluation point and measure evaluation point, which were registered in the project data table, as for the retracement data registered after the previous update processing, a point value calculated by totaling up the issue evaluation point calculated in the evaluation point calculation processing and the adjustment score stored in the storage device such as the main memory at the step S255 is stored into the project data table. In addition, as for other retracement data, a point value calculated by totaling up the calculated evaluation point and the adjustment score stored in the project data table is stored into the project data table. The same processing is carried out for the measure evaluation point.

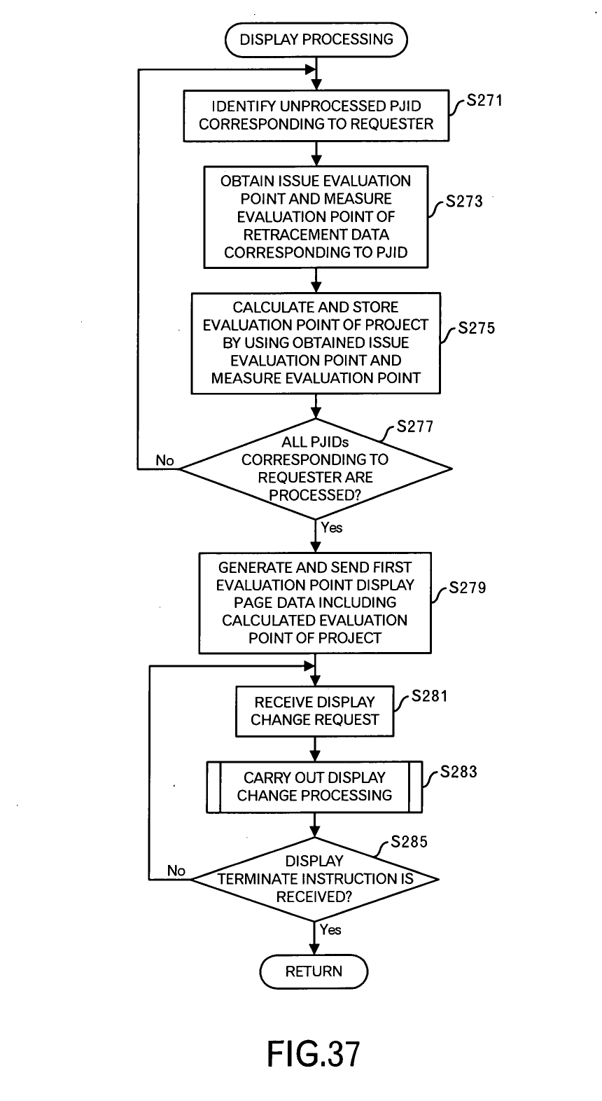

Returning to the processing of FIG. 24, when it is judged that it is not the predetermined time (step S211: No route), or after the step S213, the input/output processor 91 judges whether or not an evaluation point display request is received from a user terminal B operated by an executive K in charge of the project, for example (step S221). When the evaluation point display request is received (step S221: Yes route), a display processing is carried out (step S223). The display processing will be explained by using FIGS. 37 to 43.

First, the input/output processor 91 refers to the project management table (FIG. 23) to identify the PJIDs corresponding to the requester of the evaluation point display request and to further identify one unprocessed PJID among the identified PJIDs (step S271 in FIG. 37). In this embodiment, the project executive K is in charge of the projects of PJID “1” and PJID “2”, and the PJID “1” is firstly identified at the step S271. Next, the input/output processor 91 obtains the issue evaluation points and measure evaluation points of the retracement data corresponding to the identified PJID (step S273). In this embodiment, for example, the retracement data for one month in the past is obtained.

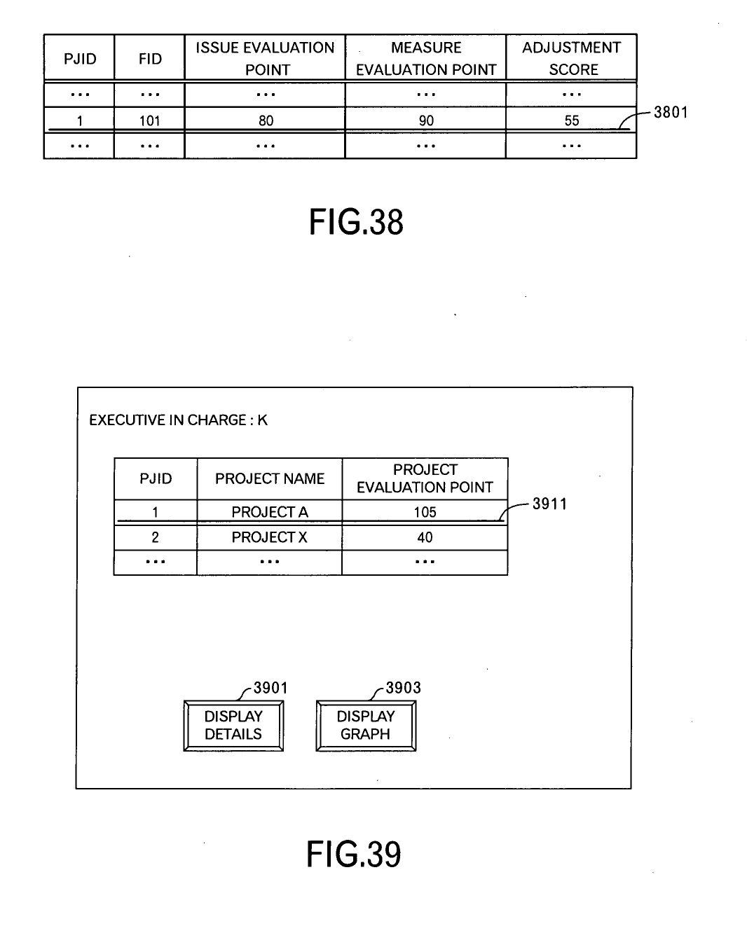

An example of the project data table including the retracement data when the display processing is carried out is shown in FIG. 38. In the record shown in a line 3801 of FIG. 38, as a result in which the issue and measure are further reused, the issue evaluation point is further increased by “15” points and the measure evaluation point is also increased by “10” points, compared with the record shown in the line 3603 of FIG. 36. On the other hand, because the adjustment score is recalculated only in the update processing carried out when the retracement data was registered and on the next day of the date when the retracement data was registered, the adjustment score does not change from the adjustment score in the record shown in the line 3603 of FIG. 36.

Next, the input/output processor 91 calculates the evaluation point of the project corresponding to the identified PJID by using the obtained issue evaluation points and measure evaluation points, and stores the calculated evaluation point into the storage device such as the main memory (step S275). In this embodiment, the evaluation point of the project is calculated by totaling up an average value of the issue evaluation points for one month in the past and an average value of the measure evaluation points for one month in the past.

Next, the input/output processor 91 judges whether or not all of the PJIDs corresponding to the requester have been processed (step S277). When there is an unprocessed PJID (step S277: No route), the processing returns to the step S271. On the other hand, when the processing for all of the PJIDs has been completed (step S277: Yes route), the input/output processor 91 generates first evaluation point display page data by using the evaluation point of the project, which is stored in the storage device such as the main memory, and transmits the first evaluation point display page data to the user terminal B (step S279).

The user terminal B receives the first evaluation point display page data from the retracement data evaluation apparatus 9, and displays the page on the display device. For example, a list display screen of the evaluation points for each project as shown in FIG. 39 is displayed on the display device. The screen example of FIG. 39 displays an ID of the executive in charge, who is the requester, a table including an ID of the project, which the executive is in charge of, a project name and a project evaluation point, a detail display button 3901 and a graph display button 3903.

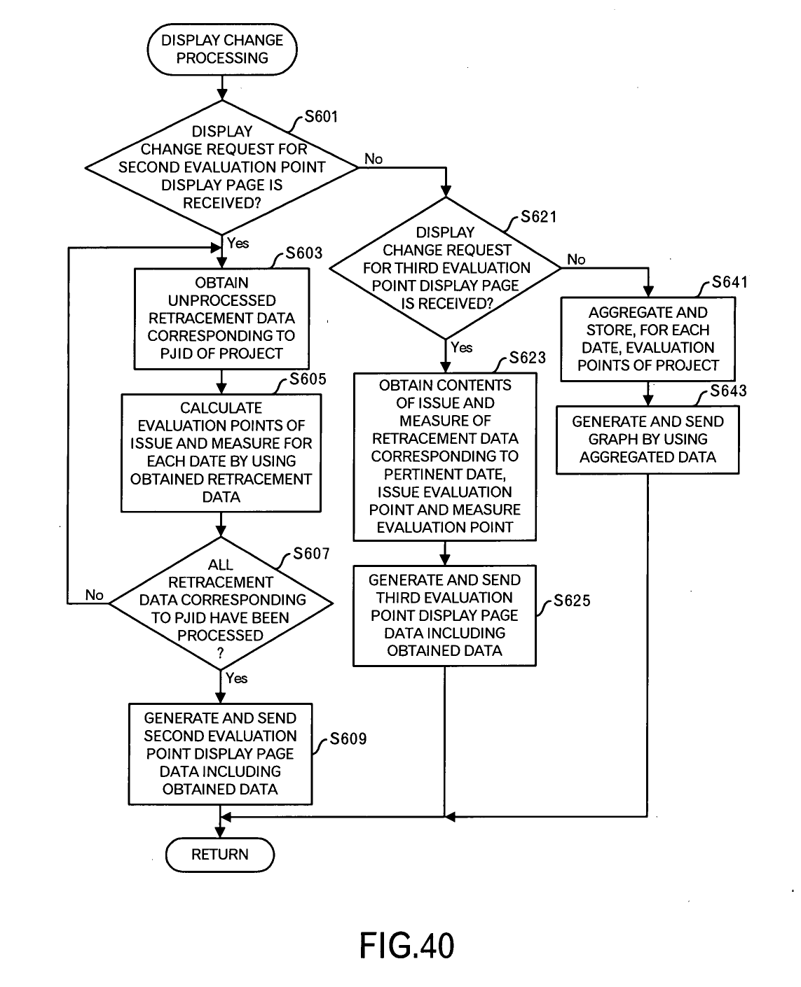

Returning to the explanation of FIG. 37, after that, the executive K in charge of the project selects a line of a specific project in the list display screen of the evaluation points for each project, which is shown in FIG. 39, and further clicks the detail display button 3901 or the graph display button 3903 to instruct the user terminal B to transmit a display change request to the retracement data evaluation apparatus 9. The user terminal B accepts the display change request from the executive K in charge of the project, and transmits the display change request to the retracement data evaluation apparatus 9 according to the instruction. The input/output processor 9 of the retracement data evaluation apparatus 9 receives the display change request from the user terminal B (step S281), and carries out a display change processing (step S283). The display change processing will be explained by using FIGS. 40 to 43. Incidentally, in this embodiment, in addition to the list display screen (i.e. first evaluation point display page data) of the evaluation points for each project, which is shown in FIG. 39, a list display screen (i.e. second evaluation point display page data) of the evaluation points of the project for each date, a detail display screen (i.e. third evaluation point display page data) of the retracement data and a graph screen indicating the progress of the evaluation points of the project can be selected. However, the screen display is not limited to those screens.

First, the input/output processor 91 judges whether or not the received display change request is for the second evaluation point display page data (step S601 in FIG. 40). For example, the executive K in charge of the project selects a line 3911 of the PJID “1” shown in FIG. 39 and clicks the detail display button 3901. Then, the user terminal B transmits a display request of the second evaluation point page data for the project whose PJID is “1”.

When receiving the display change request for the second evaluation point display page data for a specific project (step S601: Yes route), the input/output processor 91 refers to the project data table shown in FIG. 38 to obtain unprocessed retracement data among the retracement data corresponding to the PJID of the identified project (step S603). Next, the input/output processor 93 calculates an evaluation point of the project for each date by using the issue evaluation point and measure evaluation point, which are included in the obtained retracement data (step S605). In this embodiment, the total of the issue evaluation point and measure evaluation point, which are included in the retracement data, is handled as an evaluation point of the project on the day when the retracement data is registered. However, when plural records of the retracement data are registered on the same day, an average value of the totals of the issue evaluation point and measure evaluation point, which are included in each record of the retracement data, is handed as the evaluation point of the project on that day.

Next, the input/output processor 91 judges whether or not all the retracement data corresponding to the identified PJID have been processed (step S607). When there is unprocessed retracement data (step S607: No route), the processing returns to the step S603. On the other hand, when all the retracement data have completely been processed (step S607: Yes route), the input/output processor 91 generates the second evaluation point display page data by using the evaluation point of the project for each date, which is calculated at the step S605, and transmits the page data to the user terminal B (step S609).

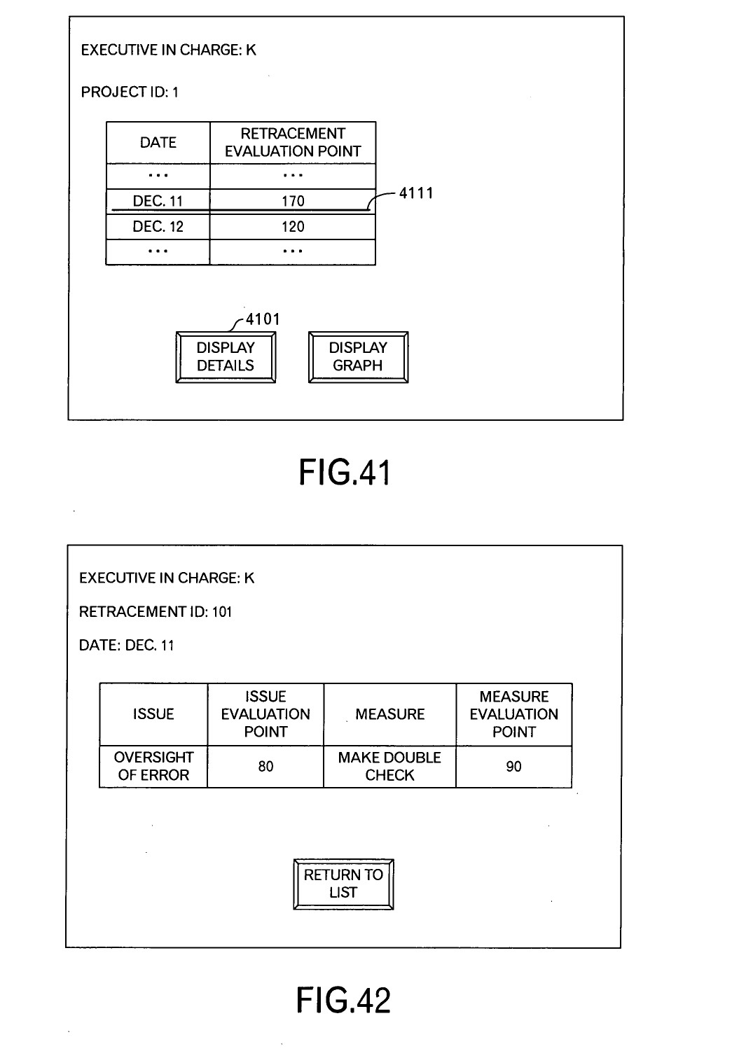

The user terminal B receives the second evaluation point display page data from the retracement data evaluation apparatus 9, and displays the page on the display device. For example, a screen as shown in FIG. 41 is displayed. In the example of FIG. 41, the evaluation point of the project PJID “1” is listed for each date.

Returning to the processing of FIG. 40, when the received display change request is not for the second evaluation point display page data (step S601: No route), the input/output processor 91 judges whether or not the received display change request is for the third evaluation point display page data (step S621 in FIG. 40). For example, the executive K in charge of the project selects a line 4111 on December 11th among the evaluation points of the project for each date, which are shown in FIG. 41, and clicks the detail display button 4101. Then, the user terminal B transmits the display change request for the third evaluation display page data for the retracement data registered on December 11th.

When receiving the display change request for the third evaluation point display page data for a specific date (step S621: Yes route), the input/output processor 91 refers to the project data table, the retracement data table (FIG. 17), the issue data table (FIG. 19) and the measure data table (FIG. 20) to obtain the content of the issue of the retracement data corresponding to the specific date, the content of the measure, the issue evaluation point and the measure evaluation point (step S623). Then, the input/output processor 91 generates the third evaluation point display page data by using the content of the obtained issue, the content of the measure, the issue evaluation point and the measure evaluation point, and transmits the page data to the user terminal B (step S625). Then, the processing returns to the original processing. Incidentally, when plural records of the retracement data are registered on the same date, the input/output processor 91 may obtain the contents of the issues in the plural records of the retracement data, the contents of the measures, the issue evaluation points and the measure evaluation points, and generate the third evaluation point display page data listing all of the retracement data.

The user terminal B receives the third evaluation point display page data from the retracement data evaluation apparatus 9, and displays the page on the display device. For example, a screen as shown in FIG. 32 is displayed on the display device. In the example of FIG. 42, the content of the issue registered on December 11th in the project of the PJID “1”, the content of the measure, the issue evaluation point and the measure evaluation point are displayed. Then, the processing returns to the processing.

Returning to the processing of FIG. 40, when the display change request is not for the third evaluation point display page data (step S621: No route), the input/output processor 91 judges that the graph display request is received, and aggregates the evaluation points of the selected project for each date (step S641). The processing for aggregating the evaluation points of the project for each date is as described above. Then, the input/output processor 91 generates graph page data by using the aggregated evaluation points of the project for each date, and transmits the page data to the user terminal B (step S643). Then, the processing returns to the original processing.

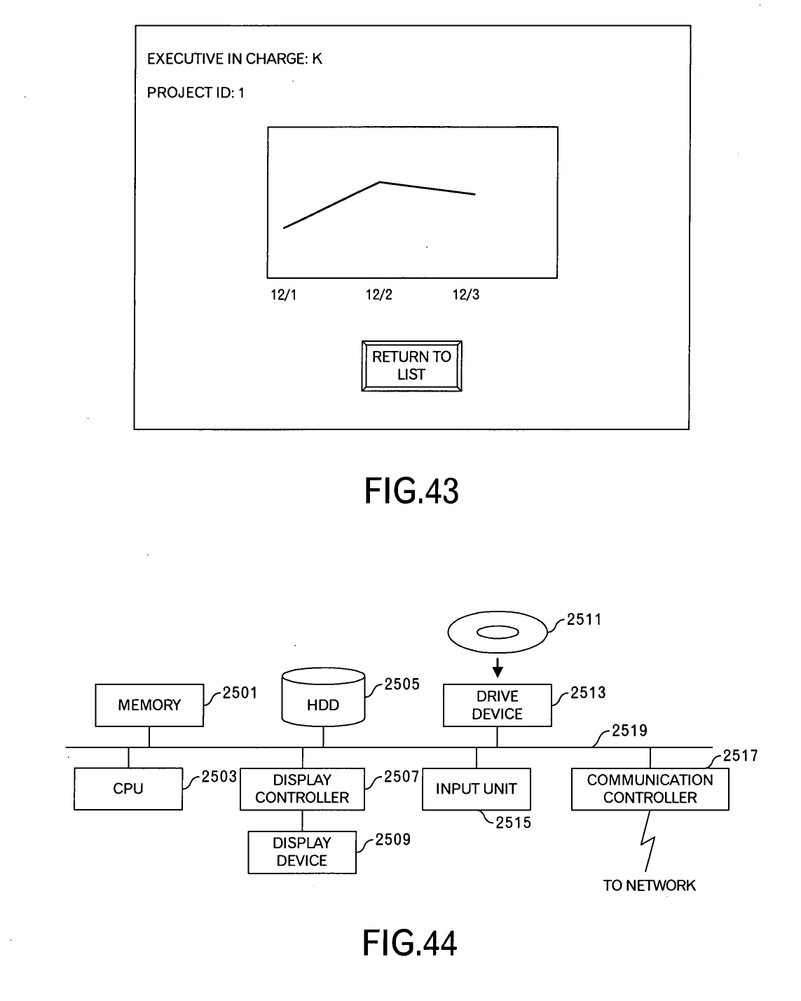

The user terminal B receives the graph page data from the retracement data evaluation apparatus 9, and displays the page on the display apparatus. For example, a screen as shown in FIG. 43 is displayed. In the example of FIG. 43, a graph showing, for each date, the progress of the evaluation points of the project, which are shown in FIG. 41. Thus, the executive in charge of the project can easily grasp the progress of the evaluation points of the project.

Returning to the processing of FIG. 37, the input/output processor 91 judges whether or not a display terminate instruction is received from the user terminal B (step S285). When the display terminate instruction is received (step S285: Yes route), the processing returns to the original processing. On the other hand, when the display terminate instruction is not received (step S285: No route), the processing returns to the step S281. Incidentally, even when the display terminate instruction is not received, it is possible to return to the original processing after a predetermined period, for example.

Returning to the processing of FIG. 24, when the evaluation point display request is not received (step S221: No route), or after the step S223, the input/output processor 91 returns to the step S201 to repeat the processing.

Although the second embodiment of this invention was explained above, this invention is not limited to this embodiment. Specifically, the functional block diagram shown in FIG. 16 is a mere example, and an actual program module configuration does not always correspond to the functional block configuration.

The first to third issue evaluation points in this embodiment are represented by an expression as follows: ((the number of other issues, which reuse a specific issue)*10+(the score data registered by a project, which reuses the specific issue)*5+(the number of measure newly registered for the specific issue)*15). That is, the first to third issue evaluation point is respectively weighted by constants included in the expression. Similarly, the first and second measure evaluation points are represented by an expression as follows: ((the number of other measures, which reuse a specific measure)*10+(the score data registered by a project, which reuses the specific measure)*5). The adjustment score is represented by an expression as follows: ((the number of appearance times of the issue IDs, which repeatedly appear)*(−10)+(the rate of speakers for the number of members in the project)*(the number of records of the retracement data)*5+((the number of issues, which do not reuse other issues)+(the number of measures, which do not reuse other measures))*10+((the number of issues, which reuse any issue by other projects)+(the number of measures, which reuse any measure by other projects))*6+((the number of times the issue is scored)+(the number of times the measure is scored))*3). However, these are mere examples of weighting, and it is possible to change the weights if necessary. For example, the weights of the adjustment score, which is changed by registering the retracement data in the project to be considered, may be greater than the weights of the evaluation point, which is mainly changed when the issue or measure is reused by the project other than the project to be considered.

In addition, instead of a processing for dividing the issue or measure into words and comparing words in the reuse judgment processing, a processing for judging whether or not a character matching rate between a character string of the received content of the issue or measure and a character string of the content of the identified issue or measure is equal to or more than a predetermined value may be carried out.

Furthermore, although the total value of the issue evaluation point calculated in the evaluation point calculation processing and the adjustment score calculated in the adjustment score calculation processing is registered in the column of the issue evaluation point in the project data table in this embodiment, the issue evaluation point before adding the adjustment score may be stored. In this case, when obtaining the issue evaluation point in the display processing, the input/output processor 91 totals up the point value registered in the column of the issue evaluation point and the point value registered in the column of the adjustment score. As for the column of the measure evaluation point, the similar matter can be applied.

Incidentally, when generating the input page data in the input processing, the issue evaluation point and measure evaluation point may be obtained from the project data table, and they may be included in the input page data in addition to the content of the issue and the like. Thus, the member of the project can identify which issue or measure is highly evaluated.

Incidentally, the user terminal, the progress management apparatus 3, and the retracement processing apparatus 5, which are shown in the first embodiment, and the user terminal and the retracement data evaluation apparatus 9, which are shown in the second embodiment, are computer devices as shown in FIG. 44. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In these embodiments of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A retracement data processing method, comprising:
obtaining project data including a target type of a project, data concerning a scale of said project, and a pertinent phase of said project;
calculating an overall similarity for retracement data of each past project, which is stored in a retracement data storage storing a target type of a past project, data concerning a scale of said past project, a specific phase of said past project, data concerning a problem in said specific phase of said past project, and data concerning an action against a problem in said specific phase of said past project, by using a first similarity against said target type of said project, a second similarity against said data concerning said scale of said project, and a third similarity against said phase of said project; and
reading out, based on said overall similarity, from said retracement data storage, said data concerning said problem in said specific phase of said past project, or said data concerning said problem in said specific phase of said past project and said data concerning said action against said problem in said specific phase of said past project.

2. The retracement data processing method as set forth in claim 1, further comprising:
obtaining data concerning a problem in said pertinent phase of said project;
calculating a fourth similarity against said data concerning said problem in said pertinent phase of said project for said retracement data of said past project, which is stored in the retracement data storage, and modifying said overall similarity by using said fourth similarity; and
reading out, based on the modified overall similarity, from said retracement data storage, said data concerning said action against said problem in said specific phase of said past project, or said data concerning said action against said problem in said specific phase of said past project and said data concerning said problem in said specific phase of said past project.

3. The retracement data processing method as set forth in claim 2, further comprising:
obtaining data concerning an action against a problem in said pertinent phase of said project;
calculating a fifth similarity against said data concerning said action against said problem in said pertinent phase of said project for said retracement data of said past project, which is stored in the retracement data storage, and modifying said overall similarity by using said fifth similarity;
reading out, based on the modified overall similarity, from said retracement data storage, said data concerning said action against said problem in said specific phase of said past project, or said data concerning said action against said problem in said specific phase of said past project and said data concerning said problem in said specific phase of said past project.

4. The retracement data processing method as set forth in claim 1, further comprising:
obtaining at least one of data concerning a delay of a schedule, data concerning a package program utilized in a system development, data concerning a hardware utilized in said system development, and data concerning an operating system utilized in said system development, and
wherein, in said calculating said overall similarity, at least one of a similarity against said data concerning said delay of said schedule, a similarity against said data concerning said package program utilized in said system development, a similarity against said data concerning said hardware utilized in said system development, and a similarity against said data concerning said operating system utilized in said system development is further utilized.

5. The retracement data processing method as set fort in claim 1, wherein said second similarity against said data concerning said scale of said project is identified by judging whether or not a class corresponding to said data concerning said scale of said project coincides with a class corresponding to said data concerning said scale of said past project, and said third similarity against said pertinent phase of the project are identified by judging whether or not a class corresponding to said pertinent phase of said project coincides with a class corresponding to said pertinent phase of said past project.

6. The retracement data processing method as set forth in claim 2, wherein said modifying by using said fourth similarity comprises:
generating a first vector concerning words appeared in said data concerning said problem in said pertinent phase of said project;
generating a second vector concerning words appeared in said data concerning said problem in said specific phase of said past project; and
calculating a similarity based on an inner-product of said first and second vectors by using said first and second generated vectors.

7. The retracement data processing method as set forth in claim 1, further comprising:
obtaining data concerning a problem in said pertinent phase of said project;
calculating a second overall similarity for said retracement data of each said past project, which is stored in said retracement data storage, by using a first similarity against said target type of said project, a second similarity against said data concerning said scale of said project, and a third similarity against said phase of said project, and a fourth similarity against said data concerning said problem in said pertinent phase of said project; and
reading out, based on said second overall similarity, from said retracement data storage, said data concerning said action against said problem in said specific phase of said past project, or said data concerning said action against said problem in said specific phase of said past project and said data concerning said problem in said specific phase of said past project.

8. A program embodied on a medium, said program comprising:
obtaining project data including a target type of a project, data concerning a scale of said project, and a pertinent phase of said project;
calculating an overall similarity for retracement data of each past project, which is stored in a retracement data storage storing a target type of a past project, data concerning a scale of said past project, a specific phase of said past project, data concerning a problem in said specific phase of said past project, and data concerning an action against a problem in said specific phase of said past project, by using a first similarity against said target type of said project, a second similarity against said data concerning said scale of said project, and a third similarity against said phase of said project; and
reading out, based on said overall similarity, from said retracement data storage, said data concerning said problem in said specific phase of said past project, or said data concerning said problem in said specific phase of said past project and said data concerning said action against said problem in said specific phase of said past project.

9. The program as set forth in claim 8, further comprising:
obtaining data concerning a problem in said pertinent phase of said project;
calculating a fourth similarity against said data concerning said problem in said pertinent phase of said project for said retracement data of said past project, which is stored in the retracement data storage, and modifying said overall similarity by using said fourth similarity; and
reading out, based on the modified overall similarity, from said retracement data storage, said data concerning said action against said problem in said specific phase of said past project, or said data concerning said action against said problem in said specific phase of said past project and said data concerning said problem in said specific phase of said past project.

10. The program as set forth in claim 9, further comprising:
obtaining data concerning an action against a problem in said pertinent phase of said project;
calculating a fifth similarity against said data concerning said action against said problem in said pertinent phase of said project for said retracement data of said past project, which is stored in the retracement data storage, and modifying said overall similarity by using said fifth similarity;
reading out, based on the modified overall similarity, from said retracement data storage, said data concerning said action against said problem in said specific phase of said past project, or said data concerning said action against said problem in said specific phase of said past project and said data concerning said problem in said specific phase of said past project.

11. A retracement data processing apparatus, comprising:
a retracement data storage storing a target type of a past project, data concerning a scale of said past project, a specific phase of said past project, data concerning a problem in said specific phase of said past project, and data concerning an action against a problem in said specific phase of said past project;
a unit that obtains project data including a target type of a project, data concerning a scale of said project, and a pertinent phase of said project;
a unit that calculates an overall similarity for retracement data of each past project, which is stored in the retracement data storage, by using a first similarity against said target type of said project, a second similarity against said data concerning said scale of said project, and a third similarity against said phase of said project; and
a unit that reads out, based on said overall similarity, from said retracement data storage, said data concerning said problem in said specific phase of said past project, or said data concerning said problem in said specific phase of said past project and said data concerning said action against said problem in said specific phase of said past project.

12. The retracement data processing apparatus as set forth in claim 11, further comprising:
a unit that obtains data concerning a problem in said pertinent phase of said project;
a unit that calculates a fourth similarity against said data concerning said problem in said pertinent phase of said project for said retracement data of said past project, which is stored in the retracement data storage, and modifying said overall similarity by using said fourth similarity; and
a unit that reads out, based on the modified overall similarity, from said retracement data storage, said data concerning said action against said problem in said specific phase of said past project, or said data concerning said action against said problem in said specific phase of said past project and said data concerning said problem in said specific phase of said past project.

13. The retracement data processing apparatus as set forth in claim 12, further comprising:
a unit that obtains data concerning an action against a problem in said pertinent phase of said project;
a unit that calculates a fifth similarity against said data concerning said action against said problem in said pertinent phase of said project for said retracement data of said past project, which is stored in the retracement data storage, and modifying said overall similarity by using said fifth similarity;
a unit that reads out, based on the modified overall similarity, from said retracement data storage, said data concerning said action against said problem in said specific phase of said past project, or said data concerning said action against said problem in said specific phase of said past project and said data concerning said problem in said specific phase of said past project.

14. A retracement data evaluation method, comprising:
extracting retracement data relating to a first project by searching a retracement data storage storing retracement data including data concerning at least an issue of a project in association with a project ID of said project, by a project ID of said first project, and calculating, by using the extracted retracement data relating to said first project, an adjustment score representing contribution to a retracement activity by said first project or a state of said retracement activity, and storing said adjustment score into a score table in association with specific retracement data relating to said first project;
receiving second retracement data including an issue, which reuses a first issue included in said specific retracement data relating to said first project, and storing said second retracement data into said retracement data storage; and
calculating an evaluation point of said first issue, which represents a usefulness degree of said first issue, in a form of adding said adjustment score for said first project, which is stored in association with said specific retracement data in said score table, by using said second retracement data, and storing said evaluation point of said first issue into said score table.

15. The retracement data evaluation method as set forth in claim 14, wherein said retracement data further includes data concerning a measure corresponding to said issue of said project, and
said retracement data evaluation method further comprises:
receiving third retracement data including a measure, which reuses a first measure included in said specific retracement data, and storing said third retracement data into said retracement data storage; and
calculating an evaluation point of said first measure, which represents a usefulness degree of said first measure, in a form of adding said adjustment score for said first project, which is stored in association with said specific retracement data in said score table, by using said third retracement data, and storing said evaluation point of said first measure into said score table.

16. The retracement data evaluation method as set forth in claim 14, wherein said calculating said adjustment score is executed at least one of a timing when said specific retracement data including said first issue is registered and a timing after said specific retracement data including said first issue was registered and when a predetermined time has passed since said calculating said adjustment score was executed.

17. The retracement data evaluation method as set forth in claim 14, wherein said calculating said adjustment score comprises:
calculating said adjustment score by using at least one of (a) a number of appearance times of issues that repeatedly appear, among issues included in said retracement data relating to said first project, or a number of issues that repeatedly appear, among issues included in said retracement data relating to said first project, (b) a number of input users who input an issue included in said retracement data registered within a predetermined period, among said retracement data relating to said first project, (c) a number of issues that do not reuse any other issues, among said issues included in said retracement data relating to said first project, (d) a number of issues that reuse an issue included in retracement data relating to other projects, among said issues included in said retracement data relating to said first project, and (e) a number of issues to which score data is input by a member of said first project.

18. The retracement data evaluation method as set forth in claim 14, wherein said retracement data includes data concerning a measure corresponding to said issue of said project, and
in said calculating said evaluation point of said first issue, retracement data including an issue that reuses said first issue and a measure that do not reuse any other measures is further used among said retracement data stored in said retracement data storage.

19. A program embodied on a computer-readable medium, for causing a computer to execute a retracement data evaluation, said program comprising:
extracting retracement data relating to a first project by searching a retracement data storage storing retracement data including data concerning at least an issue of a project in association with a project ID of said project, by a project ID of said first project, and calculating, by using the extracted retracement data relating to said first project, an adjustment score representing contribution to a retracement activity by said first project or a state of said retracement activity, and storing said adjustment score into a score table in association with specific retracement data relating to said first project;
receiving second retracement data including an issue, which reuses a first issue included in said specific retracement data relating to said first project, and storing said second retracement data into said retracement data storage; and
calculating an evaluation point of said first issue, which represents a usefulness degree of said first issue, in a form of adding said adjustment score for said first project, which is stored in association with said specific retracement data in said score table, by using said second retracement data, and storing said evaluation point of said first issue into said score table.

20. A retracement data evaluation apparatus, comprising:
a unit that extracts retracement data relating to a first project by searching a retracement data storage storing retracement data including data concerning at least an issue of a project in association with a project ID of said project, by a project ID of said first project, and calculates, by using the extracted retracement data relating to said first project, an adjustment score representing contribution to a retracement activity by said first project or a state of said retracement activity, and stores said adjustment score into a score table in association with specific retracement data relating to said first project;
a unit that receives second retracement data including an issue, which reuses a first issue included in said specific retracement data relating to said first project, and stores said second retracement data into said retracement data storage; and
a unit that calculates an evaluation point of said first issue, which represents a usefulness degree of said first issue, in a form of adding said adjustment score for said first project, which is stored in association with said specific retracement data in said score table, by using said second retracement data, and stores said evaluation point of said first issue into said score table.
